(19) United States
(12) Patent Application Publication
(10) Pub. No.: US 2007/0198311 A1
(43) Pub. Date: Aug. 23, 2007

(54) SYSTEM AND METHOD FOR COMPLETING A RENTAL AGREEMENT ONLINE

(76) Inventors: NEREIDA MARIA MENENDEZ, Ft. Lauderdale, FL (US); Paula S. Williams, Bal Harbour, FL (US)

Correspondence Address: ECKERT SEAMANS CHERIN & MELLOTT, 600 GRANT STREET, 44TH FLOOR, PITTSBURGH, PA, 15219, US

(21) Appl. No.: 11/692,308

(22) Filed: Mar. 28, 2007

Related U.S. Application Data
(62) Division of application No. 09/698,491, filed on Oct. 27, 2000.

(51) Int. Cl. G06Q 10/00

(52) U.S. Cl. 705/5

(57) ABSTRACT

A method for completing a rental contract online includes entering reservation-related information and rental-related information for an item or service, such as a vehicle rental service. The entering step enters: (a) the rental-related information without employing a master rental agreement, such as a user's master agreement with a vehicle rental club, or (b) at least some of the rental-related information from a master rental agreement and allows modification of the information from the master rental agreement for rental of the item or service without modifying the master rental agreement. A reservation for the item or service is provided based at least in part upon the reservation-related information. A rental proposal is created and displayed based upon the reservation and the rental-related information. The rental proposal is accepted online, and the rental contract, which is based upon the accepted rental proposal, is displayed.

This application is a divisional of application Ser. No. 09/698,491, filed Oct. 27, 2000, and entitled “System And Method For Completing A Rental Agreement Online”.

### CROSS-REFERENCE TO RELATED APPLICATIONS

This application is related to commonly assigned, copending U.S. patent application Ser. No. 09/698,552, filed Oct. 27, 2000, entitled “Method for Completing a Rental Agreement Online and Bypassing a Rental Counter”; and 09/698,502, filed Oct. 27, 2000, entitled “Method For Completing And Storing An Electronic Rental Agreement”.

### BACKGROUND OF THE INVENTION

1. Field of the Invention

The present invention relates to a system and method for completing a rental agreement and, more particularly, to a system and method for completing a rental agreement for an item or service, such as a vehicle rental service, online over a communication channel or network, such as the Internet.

2. Background Information

The Internet comprises a vast number of computers and computer networks that are interconnected through communication links. The interconnected computers exchange information using various services, such as electronic mail (i.e., e-mail), and the World Wide Web (“WWW”). The WWW service allows a server computer system (e.g., a web server, a web site) to send graphical web pages of information to a remote client computer system. The remote client computer system can then display the web pages. Each resource (e.g., computer, web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page, it typically displays the web page using a browser. A browser is a special-purpose application program that effects the requesting of web pages and the displaying of web pages.

Currently, web pages are typically defined using HyperText Markup Language (“HTML”). HTML provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems.

The World Wide Web is especially conducive to conducting electronic commerce (i.e., e-commerce). Many web servers have been developed through which vendors can advertise and sell products or enter reservations for items or services, such a vehicle rentals.

A typical evaluation process for a vehicle rental reservation on a web site on the Internet includes the repetition (for a desired number of different vehicles) of seven steps across a plurality of different web pages. The seven steps, which are employed to determine the availability of one vehicle, include: (1) entering a user's personal information; (2) entering the pick-up date, location and time of the desired rental; (3) entering the drop-off date and time (and optionally the drop-off location) for the rental; (4) selecting a vehicle type; (5) entering other applicable information and clicking to request the rental availability, rates and reservation information for the selected vehicle type; (6) displaying the rental availability, rates and reservation information for the user; and (7) displaying the user-entered information. After these steps, the user may click to reserve the particular vehicle.

It is known to provide a master rental proposal and to accept such proposal, in handwriting, in order to provide a master rental agreement, such as a car rental club agreement.

It is also known to online-modify a pre-existing master rental agreement.

It is further known to online-enter a reservation based upon a pre-existing master rental agreement, in order to bypass a rental counter at a rental facility.

There is room for improvement in systems and methods for online reservations.

### SUMMARY OF THE INVENTION

Known conventional reservation methods and systems do not permit a user to complete an online rental agreement for a vehicle without employing a pre-existing master rental agreement. Furthermore, such systems do not permit a user to complete an online rental agreement with rental-related information that is different from that which is contained in the master rental agreement.

The present system and method permit online completion of a rental agreement and entry of: (a) rental-related information without employing a master rental agreement, or (b) at least some of the rental-related information from a master rental agreement and modification of the information from the master rental agreement for rental of an item or service without modifying the master rental agreement.

In accordance with the invention, a method for completing a rental agreement online comprises: entering reservation-related information and rental-related information for an item or service, the entering step entering: (a) the rental-related information without employing a master rental agreement, or (b) at least some of the rental-related information from a master rental agreement and allowing modification of the information from the master rental agreement for rental of the item or service without modifying the master rental agreement; providing a reservation for the item or service based at least in part upon the reservation-related information; creating and displaying a rental proposal based upon the reservation and the rental-related information; accepting the rental proposal online; and displaying a rental agreement based upon the accepted rental proposal.

As one refinement, the method enters the rental-related information without employing a master rental agreement.

As another refinement, the method enters at least some of the rental-related information from a master rental agreement; and allows modification of the information from the master rental agreement for rental of the item or service without modifying the master rental agreement. Preferably, at least one of a member identification and a user name is entered to identify the master rental agreement.

As another refinement, a history of rental information for prior rentals by a user is maintained; information from an identification of a user is entered; and at least some of the rental-related information is entered from the history based upon the information from an identification of a user without employing a master rental agreement.

As a further refinement, an e-mail message is sent to confirm the reservation after entering the reservation-related information and providing the reservation, and the rental-related information is entered after receiving the e-mail message. Preferably, the method includes linking from the e-mail message to a web page to complete the rental agreement.

As another aspect of the invention, a method for completing a rental agreement between a client system and a server system comprises: under control of the client system, entering first information pertaining to a reservation of an item or service, and second information pertaining to a rental of the item or service, the entering step entering: (a) the second information without employing a master rental agreement, or (b) at least some of the second information from a master rental agreement and allowing modification of the second information from the master rental agreement for rental of the item or service without modifying the master rental agreement, sending the first information and the second information to the server system, receiving from the server system a rental proposal based upon the first information and the second information, displaying the rental proposal, and accepting the rental proposal online; and under control of the server system, receiving the first information and the second information from the client system, providing a reservation based at least in part upon the first information, generating the rental proposal based upon the reservation and the second information, and sending the rental proposal to the client system.

As a further aspect of the invention, a client system for completing a rental agreement with a server system comprises: an entry component entering first information pertaining to a reservation of an item or service, and entering second information pertaining to a rental of the item or service, the entering step entering: (a) the second information without employing a master rental agreement, or (b) at least some of the second information from a master rental agreement and allowing modification of the second information from the master rental agreement for rental of the item or service without modifying the master rental agreement; a processor component cooperating with the entry component; a communication component, responsive to the processor component, sending the first and second information to the server system, and receiving from the server system a rental proposal responsive to the sent first and second information; and a display component displaying the rental proposal, the entry component and the processor component cooperating to initiate acceptance of the rental proposal, and the communication component, responsive to the acceptance, sending the acceptance to the server system, in order to complete the rental agreement online.

As another aspect of the invention, a server system for completing a rental agreement with a client system comprises: a data storage component storing information for a plurality of items or services; a communication and processing component receiving first information pertaining to a reservation of an item or service from the client system, and receiving second information pertaining to a rental of the item or service from the client system, a reservation component retrieving stored information from the data storage component for the items or services, and providing a reservation based at least in part upon the first information and the retrieved stored information; and a rental component generating a rental proposal based upon the reservation and the received second information, sending the rental proposal to the client system, and receiving an acceptance of the rental proposal from the client system, in order to complete the rental agreement online, the rental component receiving: (a) the second information without employing a master rental agreement, or (b) at least some of the second information from a master rental agreement and allowing modification of the second information from the master rental agreement for rental of the item or service without modifying the master rental agreement.

As a still further aspect of the invention, a method for completing a rental agreement with a server system using a client system comprises: entering first information pertaining to a reservation of an item or service, and second information pertaining to a rental of the item or service, the entering step entering: (a) the second information without employing a master rental agreement, or (b) at least some of the second information from a master rental agreement and allowing modification of the second information from the master rental agreement for rental of the item or service without modifying the master rental agreement; sending the first and second information to the server system; receiving from the server system a rental proposal responsive to the sent first and second information; displaying the rental proposal; accepting the rental proposal; and sending the acceptance to the server system, in order to complete the rental agreement online.

As another aspect of the invention, a method for completing a rental agreement with a client system using a server system comprises: storing information for a plurality of items or services; receiving from the client system first information pertaining to a reservation of an item or service, and second information pertaining to a rental of the item or service; retrieving the stored information for the items or services; providing a reservation based at least in part upon the first information and the retrieved stored information; generating a rental proposal based upon the reservation and the received second information, the generating step generating the rental proposal: (a) without employing a master rental agreement, or (b) employing at least some of the second information from a master rental agreement and allowing modification of the second information from the master rental agreement for rental of the item or service without modifying the master rental agreement; sending the rental proposal to the client system; and receiving an acceptance of the rental proposal from the client system, in order to complete the rental agreement online.

As a still further aspect of the invention, a system for completing a rental agreement comprises: a client sub-system comprising: an entry component entering first information pertaining to a reservation of an item or service, and entering second information pertaining to a rental of the item or service, the entry component entering: (a) the second information without employing a master rental agreement, or (b) at least some of the second information from a master rental agreement and allowing modification of the second information from the master rental agreement for rental of the item or service without modifying the master rental agreement, a processor component cooperating with the entry component, a communication component, responsive to the processor component, sending the first and second information to a server sub-system, and receiving from the server sub-system a rental proposal responsive to the sent first and second information, and a display component displaying the rental proposal, the entry component and the processor component cooperating to initiate acceptance of the rental proposal, and the communication component, responsive to the acceptance, sending the acceptance to the server sub-system; the server sub-system comprising: a data storage component storing information for a plurality of items or services, a communication component receiving the first and second information from the client sub-system, a reservation component retrieving stored information from the data storage component for the items or services, and providing a reservation based at least in part upon the first information and the retrieved stored information, a rental component generating a rental proposal based upon the reservation and the received second information, and a processor component cooperating with the communication component, the reservation component and the rental component to provide the reservation, to send the rental proposal to the client sub-system and to receive an acceptance of the rental proposal from the client sub-system, in order to complete the rental agreement online; and a communication sub-system communicating between the communication component of the client sub-system and the communication component of the server sub-system.

As another aspect of the invention, a method for completing a rental agreement online and obtaining an item or service for rental comprises: entering reservation-related information and rental-related information for the item or service, the entering step entering: (a) the rental-related information without employing a master rental agreement, or (b) at least some of the rental-related information from a master rental agreement and allowing modification of the information from the master rental agreement for rental of the item or service without modifying the master rental agreement; providing a reservation for the item or service based at least in part upon the reservation-related information; creating and displaying a rental proposal based upon the reservation and the rental-related information; accepting the rental proposal online; displaying the rental agreement based upon the accepted rental proposal; and going to a rental counter before obtaining the item or service for rental.

### BRIEF DESCRIPTION OF THE DRAWINGS

A full understanding of the invention can be gained from the following description of the preferred embodiments when read in conjunction with the accompanying drawings in which:

FIG. 1 is a block diagram of a rental/reservation process in accordance with an embodiment of the present invention.

FIG. 2 is a block diagram of a client/server system in accordance with another embodiment of the present invention.

FIG. 3 is a block diagram of a vehicle reservation and rental process in accordance with another embodiment of the present invention.

FIG. 4 is a block diagram of a client/server system in accordance with another embodiment of the present invention.

FIG. 5 is a block diagram of a vehicle reservation and rental process in accordance with another embodiment of the present invention.

FIG. 6A is a block diagram showing a link from a home web page to a second web page, which presents an overview of exemplary steps, in accordance with an embodiment of the present invention.

FIG. 6B is a “tell us about your trip” web page as displayed by the client system of FIG. 2 after the display of the second web page of FIG. 6A.

FIG. 6C is a “select a vehicle” web page (after a calculation) as displayed by the client system of FIG. 2.

FIG. 6D is a “select rental options and calculate total” web page as displayed by the client system of FIG. 2 after the display of the web page of FIG. 6C.

FIG. 6E is a “reservation confirmation” web page as displayed by the client system of FIG. 2.

FIG. 6F is a “tell us about yourself” web page as displayed by the client system of FIG. 2.

FIG. 6G is an “additional driver” web page as displayed by the client system of FIG. 2 after the display of the web page of FIG. 6F.

FIG. 6H is a “your past rentals” web page as displayed by the client system of FIG. 2 after the display of the web pages of FIG. 6F or 6G.

FIG. 6I is an “optional equipment” web page as displayed by the client system of FIG. 2 after the display of the web page of FIG. 6H.

FIG. 6J is a “review your rental” web page as displayed by the client system of FIG. 2 after the display of the web page of FIG. 6I.

FIG. 6K is a “terms and conditions” web page as displayed by the client system of FIG. 2 after the display of the web page of FIG. 6J.

FIG. 6L is a “rental confirmation” web page as displayed by the client system of FIG. 2 after the display of the web page of FIG. 6K.

FIGS. 7A-7C are flow diagrams of the system of FIG. 2.

### DESCRIPTION OF THE PREFERRED EMBODIMENTS

As employed herein, the term “vehicle” shall expressly include, but not be limited to, any new or used vehicle having pneumatic tires, such as, for example, land-based vehicles, automobiles, cars, trucks, sport utility vehicles (SUVs), vans, motorcycles, mopeds, campers, trailers, and bicycles.

As employed herein, the term “item” shall expressly include, but not be limited, to any product or good which is available for reservation, such as, for example, a vehicle.

As employed herein, the term “service” shall expressly include, but not be limited, to any service which is available for reservation, such as, for example, a vehicle rental service.

As employed herein, the term “communication network” shall expressly include, but not be limited to, any local area network (LAN), wide area network (WAN), intranet, extranet, wireless communication system, global communication network, and the Internet.

As employed herein, the term “personal information” shall expressly include, but not be limited to, information pertaining to a natural person, firm, corporation, association, group or organization.

As employed herein, the term “rental facility” shall expressly include, but not be limited to, a facility, which provides rentals of items or services, such as, for example, a car rental facility of a car rental vendor at or near an airport (e.g., an airport in Miami, Fla.; an airport in Los Angeles Calif.; an airport in Boston, Mass.).

As employed herein, the term “rental counter” shall expressly include, but not be limited to, a rental counter, which its typically staffed by one or more persons, at or near a rental facility.

As employed herein, the term “kiosk” shall expressly include, but not be limited to, a rental station, which its typically not staffed by any persons, at a rental facility.

As employed herein, the term “vehicle rental lot” shall expressly include, but not be limited to, a parking lot, building or area for rental vehicles at a rental facility.

As employed herein, the term “exit gate” shall expressly include, but not be limited to, an exit, which its typically staffed by one or more persons, from a vehicle rental lot at a rental facility.

As employed herein, the term “HTML” shall expressly include, but not be limited, to HTML, dHTML (dynamic HTML), and other suitable technologies to produce a web page.

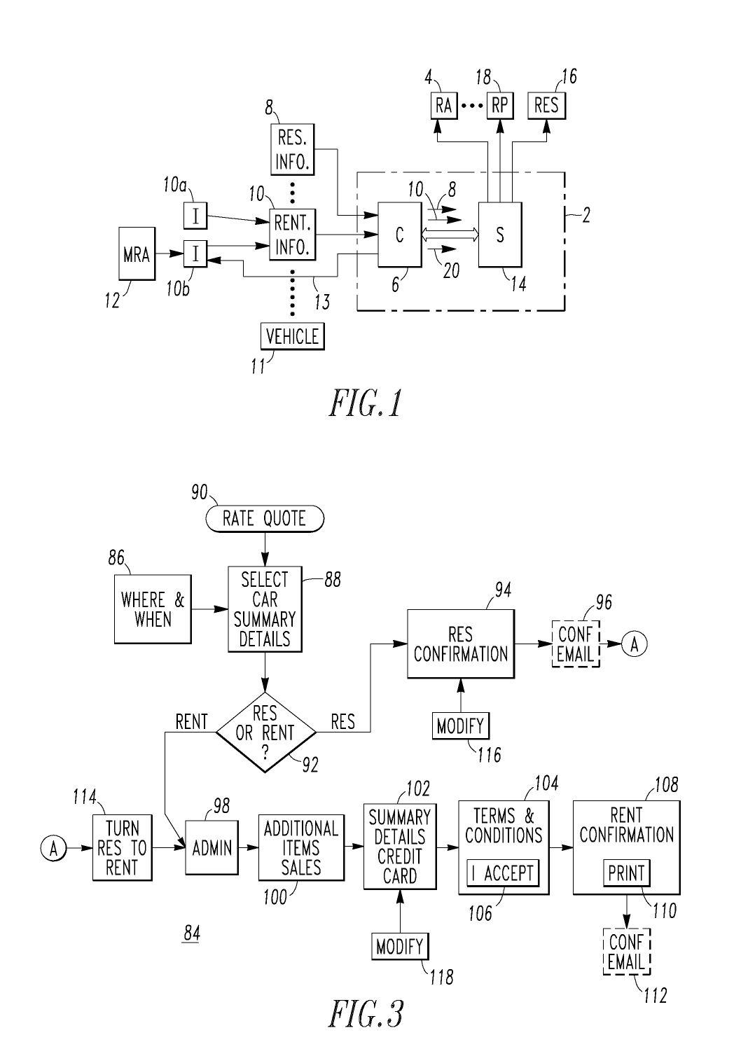

FIG. 1 illustrates a process, which in the exemplary embodiment employs a client/server system 2, to complete a rental agreement (RA) 4 online. At a client system (C) 6, reservation-related information (RES. INFO.) 8 and rental-related information (RENT. INFO.) 10 are entered for an item or service, such as a vehicle 11 or a vehicle rental service. The rental-related information 10 is entered in one of two manners: (a) information (I) 10a is entered without employing a master rental agreement, or (b) at least some of rental-related information (I) 10b is entered from a master rental agreement (MRA) 12, with the entry allowing modification 13 of such information 10b for rental of the vehicle 11 without modifying the master rental agreement 12.

In turn, at a server system (S) 14, a reservation (RES) 16 for the vehicle 11 is provided based at least in part upon the reservation-related information 8. Such reservation-related information 8 may include: (1) only information which is related to a reservation; and/or (2) information which is related to a reservation and a rental. A rental proposal (RP) 18 is created and displayed based upon the reservation 16 and the rental-related information 10. The rental proposal 18 is accepted online at 20. Finally, the rental agreement 4, which is based upon the accepted rental proposal 18, is displayed.

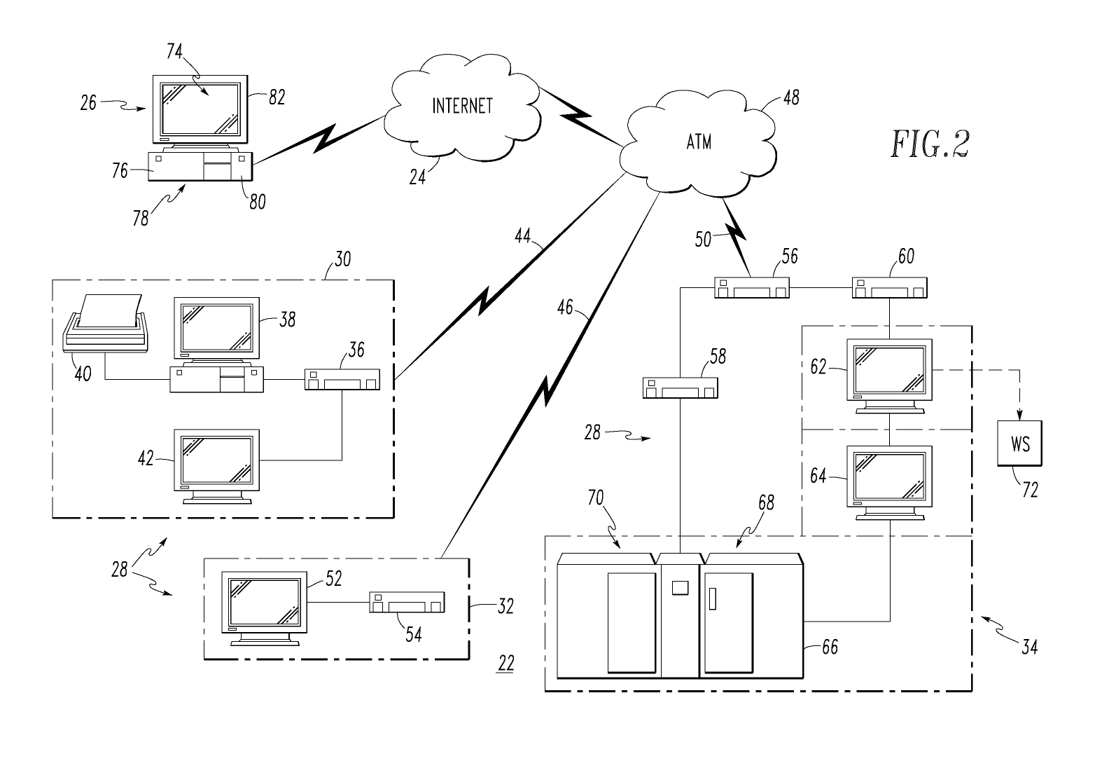

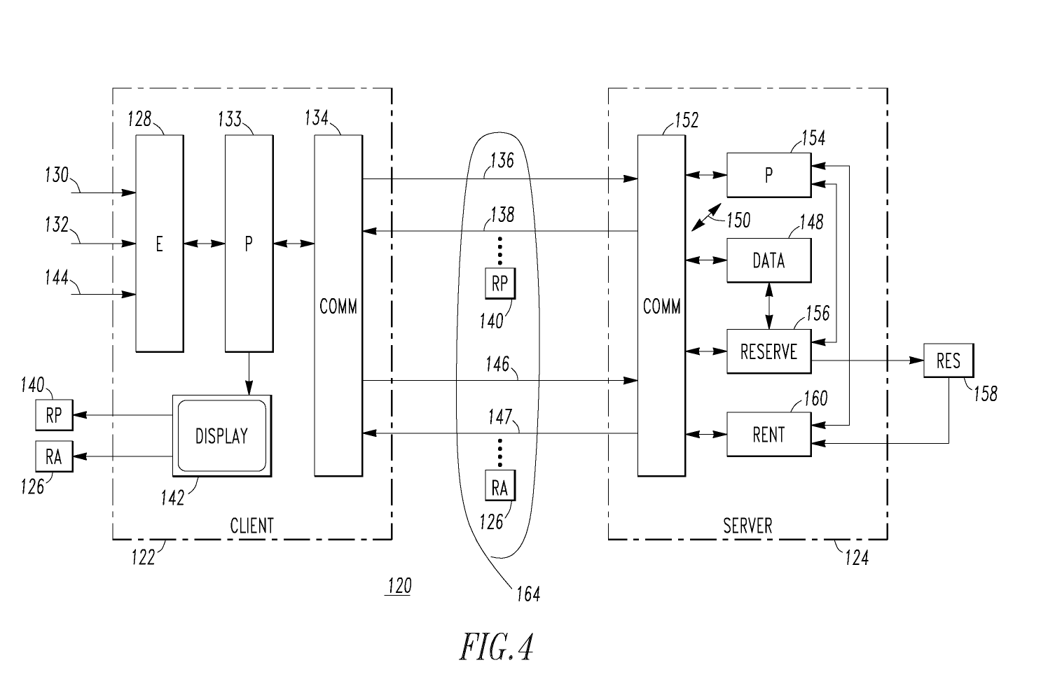

FIG. 2 illustrates an exemplary client/server system 22 which employs a suitable communication sub-system in the form of a global communication network, such as the Internet 24, between a client system 26, such as a personal computer (PC), for a consumer and a server system 28 for a rental company. The exemplary server system 28 includes a first private network 30 at a rental facility, a second private network 32 at a reservation site, and a server sub-system 34. The first private network 30 includes a router 36, a display 38 and a printer 40 at a kiosk, and one or more terminals 42 at a rental counter. The first private network 30 and the second private network 32 employ respective frame relay protocols 44 and 46 for communication with an asynchronous transfer mode (ATM) gateway 48 of the communication sub-system. The gateway 48, in turn, employs an ATM protocol 50 for communication with the server sub-system 34. The second private network 32 includes one or more terminals 52 and a router 54.

The server sub-system 34 includes an ATM switch 56, a router 58, a firewall 60, a processor component such as the exemplary web server 62 on the public side of the sub-system, a data storage component such as the exemplary database server 64 on the DMZ side of the sub-system, and a mainframe computer 66 on the private side of the sub-system. The server sub-system 34 further includes a reservation component such as the exemplary reservation system 68 running on the mainframe computer 66, and a rental component such as the exemplary rental system 70 which also runs on the mainframe computer. The web server 62 provides a web site (WS) 72 for access by consumers such as a consumer (e.g., user, customer) at the client system 26.

The client system 26 includes a display component such as the exemplary browser 74 for displaying portions of the web site 72, a data entry component 76, a processor component 78, and a communication component 80, such as a modem. With reference to FIG. 1, under control of the client system 26 of FIG. 2, a consumer enters the information 8,10 pertaining to reservation/rental of an item or service, such as the exemplary vehicle 11. Alternatively, the service may be, for example, a vehicle rental service. The components 76,78,80 cooperate to send first information as reservation-related information 8 to the web site 72, to send second information as rental-related information 10 to the web site, and to receive the rental proposal 18 from the web site. Preferably, the display component 74 displays the received rental proposal 18.

The communication sub-system 80 employs the ATM protocol 50. The ATM switch 56 and the firewall 60 form a communication component of the server sub-system 34. The client system 26 communicates with the web server 62 with the ATM protocol 50 through the ATM switch 56 and the firewall 60.

Continuing to refer to FIGS. 1 and 2, one or both of the printer 40 and the display 38 at the kiosk of the rental facility are employed for displaying the rental agreement 4. Also, one or both of the client system 26 and the display 38 at the kiosk of the rental facility may display the rental proposal 18.

The terminals 42 at the rental counter of the rental facility may also be employed for displaying the rental agreement 4. Both the frame relay protocol 44 and the ATM protocol 50 are employed between the kiosk and the rental counter of the rental facility and the server sub-system 34. However, in the exemplary embodiment, that communication is through the ATM switch 56 and the router 58.

In a preferred embodiment, the rental proposal 18 of FIG. 1 is accepted at the client system 26 of FIG. 2. Alternatively, a consumer may also accept the rental proposal 18 at the display 38 at the kiosk of the rental facility.

The web server 62 launches various requests and creates the final display of HTML pages for the exemplary client system 26. While reference has been made to the exemplary PC 26 and server 62, other suitable processors such as, for example, PDAs, other wireless devices, network- or web-PCs, microcomputers, microprocessors, workstations, minicomputers or mainframe computers may be employed.

The web server 62 receives HTTP requests from the PC 26 to access web pages of the web site 72, as identified by URLs. In response, the web server 62 provides HTML documents for display of the web pages by the client system 26.

The server sub-system 34 and client system 26 interact by exchanging information via a communication network, which may include transmission over the Internet 24, although the methods disclosed herein may be used in various environments other than the Internet. For example, an electronic mail environment may be employed. Also, various communication channels may be used such as, for example, a local area network, wide area network, or point-to-point dial up connection.

In the exemplary embodiment, communication is provided over a communication network, such as the Internet 24 using the World Wide Web (WWW). The system 22 includes one or more exemplary client systems, such as 26, and the server sub-system 34. The server sub-system 34 and the PC 26 are connected to the WWW by one or more Internet Service providers (ISPs) (not shown), in order that the PC 26 provides access to the WWW and, thus, access to web server 62 of the server sub-system 34, in order to display the web pages.

Any suitable server system may be employed which includes one or more servers or any combination of hardware or software for processing reservations and rentals. The servers 62,64 of the exemplary server sub-system 34 function, for example, on a Windows NT platform with a Microsoft IIS server software license, although the invention is applicable to a wide range of server platforms.

Furthermore, a suitable client system may comprise any combination of hardware or software that can interact with the server sub-system 34. These systems may include television-based systems or various other consumer products through which reservation/rental requests may be entered. The exemplary PC 26 employs, for example, the Microsoft Internet Explorer 4.0 or 5.0 browser running on Windows 95 or 98, although the invention is applicable to any suitable computer, browser, operating system, data entry device, and communication device.

The exemplary PC 26 includes a display 82 for the web pages, which displays information regarding the vehicle 11 of FIG. 1. The PC 26 also includes the exemplary data entry component 76, such as a keyboard (not shown), which the user employs in cooperation with the display 82, and a mouse (not shown) having one or more buttons for control of the data entry and display functions. The PC 26 and browser 74, in turn, receive and process the HTML documents from the web server 62 for display of the web pages on the display 82. The user employs the exemplary data entry component 76 to enter information pertaining to the vehicle 11 on the web pages. The PC 26, in cooperation with the ISP, and responsive to user requests, sends information to the server sub-system 34.

One or more client systems 26 and the server sub-system 34 form the client/server computer system 22 in which a global communication network, such as the Internet 24, provides a communication sub-system therebetween. The exemplary WWW sends requests to the server sub-system 34 and responsive information therefrom. Preferably, the server system 28 and the client system 26 employ Secure Socket Layer (SSL) security or another suitable security protocol (e.g., SET, PKI) in order to enhance the security of the user's reservation/rental information as communicated over the Internet 24.

The exemplary system 22 provides reservations/rentals for vehicles, such as cars, although the invention is applicable to a wide range of items or services (e.g., without limitation, equipment leasing, such as, for example, leasing of aircraft or heavy equipment; procurement processes).

FIG. 3 illustrates a block diagram of a vehicle reservation and rental process 84 in accordance with another embodiment of the invention. In the exemplary embodiment, a customer logs onto the exemplary web site 72 of FIG. 2, enters reservation-related information, and enters additional rental-related information, thereby completing enough information to finish a rental request. Then, at the client system 26, the customer clicks on an “I accept” button on a web page, which, in turn, is stored by the mainframe 66 as an electronic signature.

The exemplary web site 72 of FIG. 2 permits a customer to enter reservation-related information on the web site and complete the reservation. The customer enters the web server 62 through the ATM switch 56 and firewall 60 in order to access the web service for the corresponding domain name. In turn, the web server 62 initiates a conventional request for a reservation through the database server 64 to the reservation system 68 on the mainframe 66. Furthermore, in accordance with the present invention, the web server 62 allows the additional entry of rental-related information for the rental system 70 on the mainframe 66.

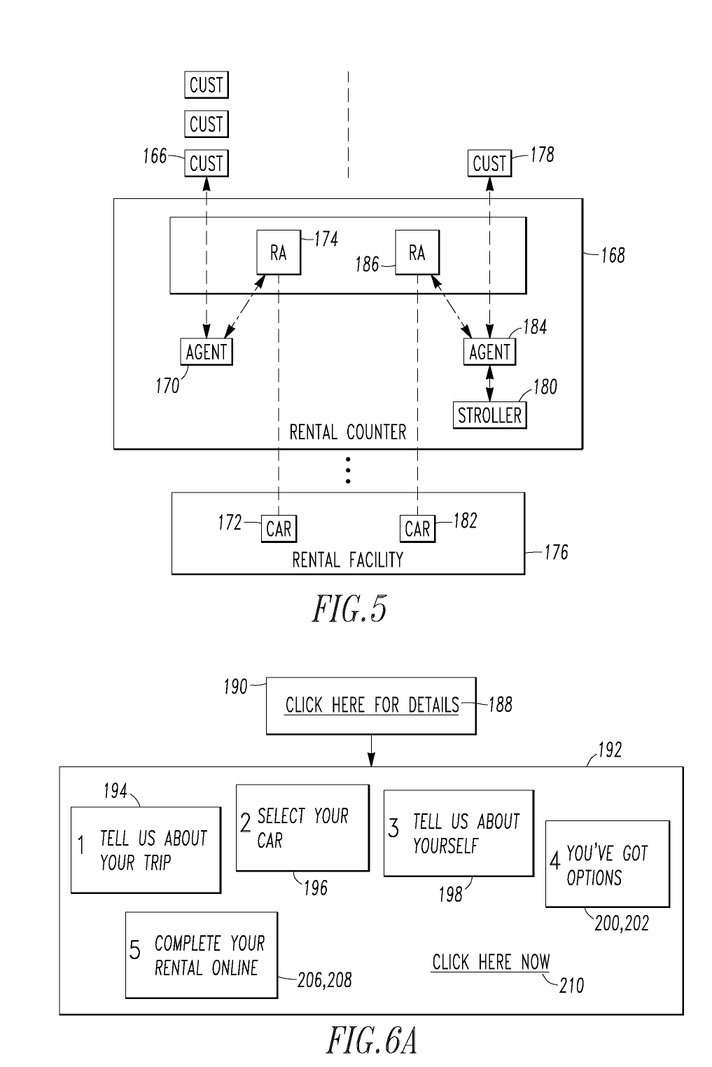

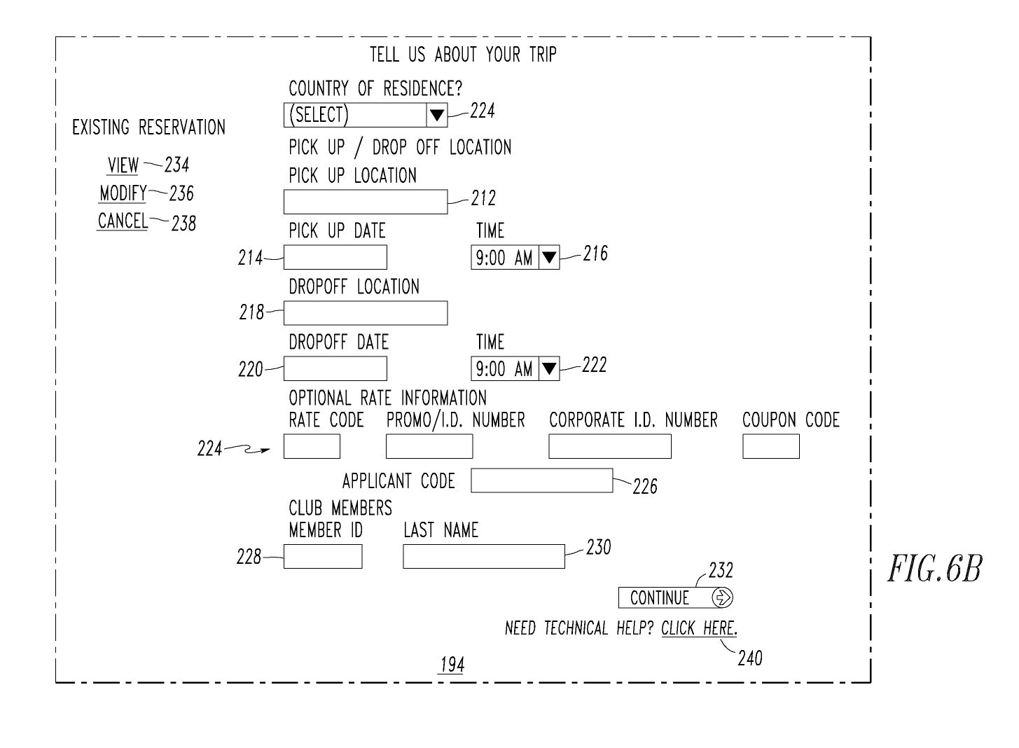

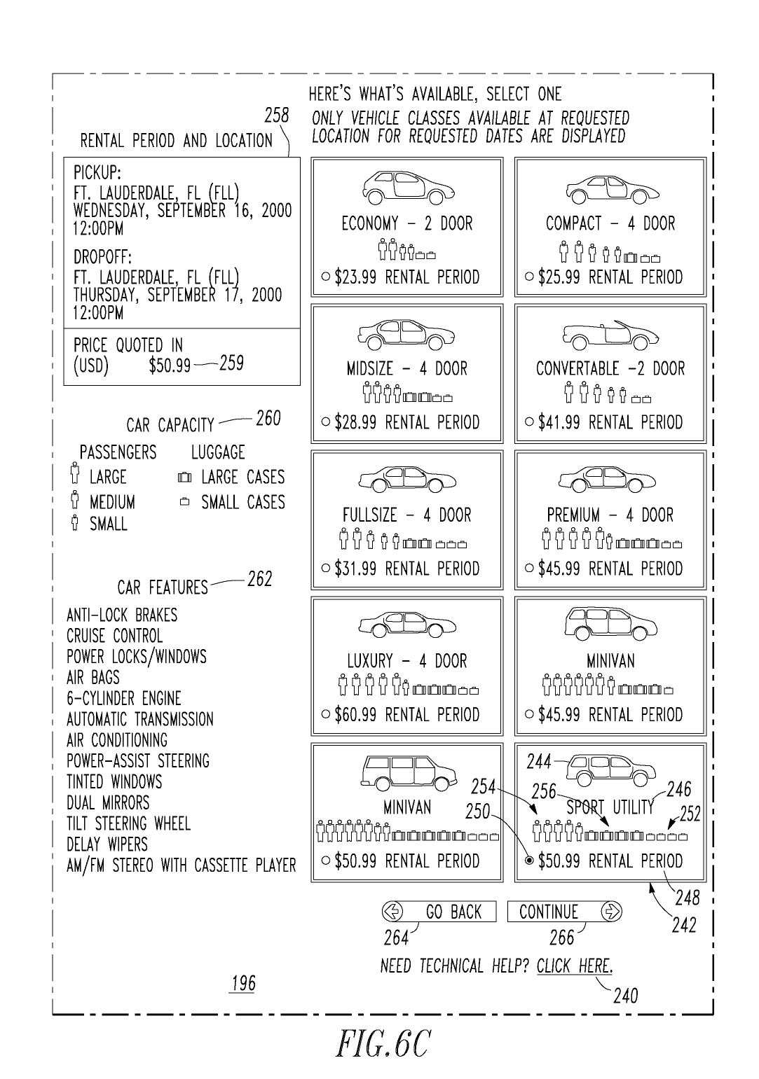

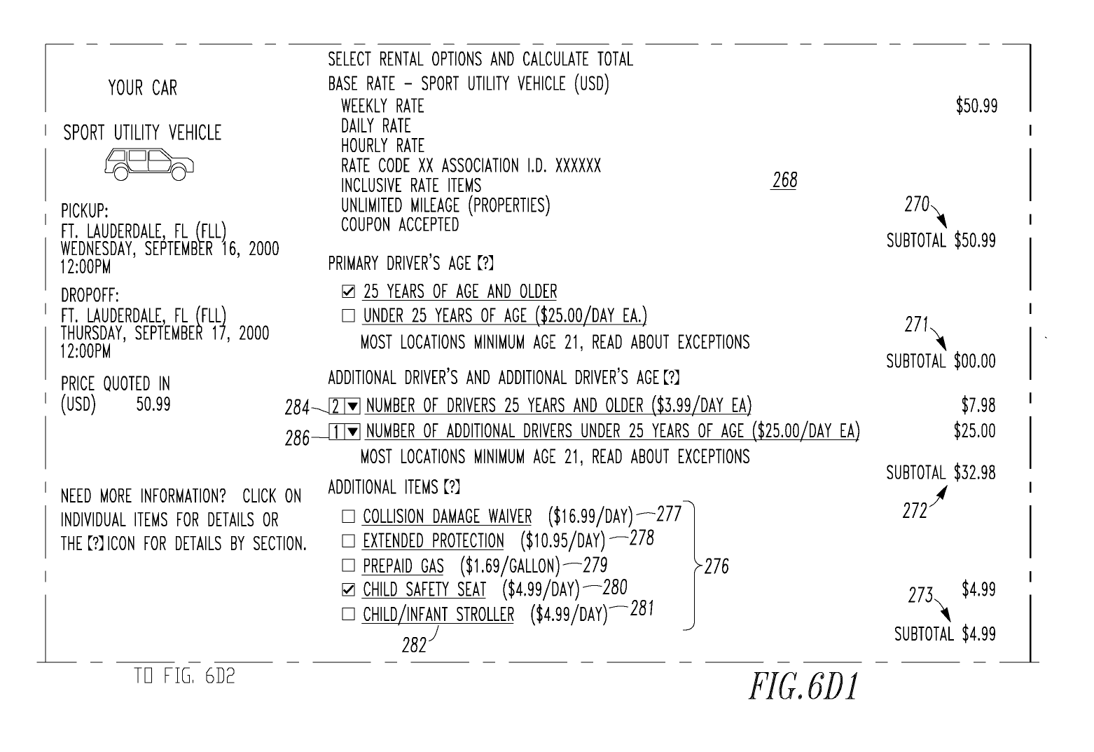

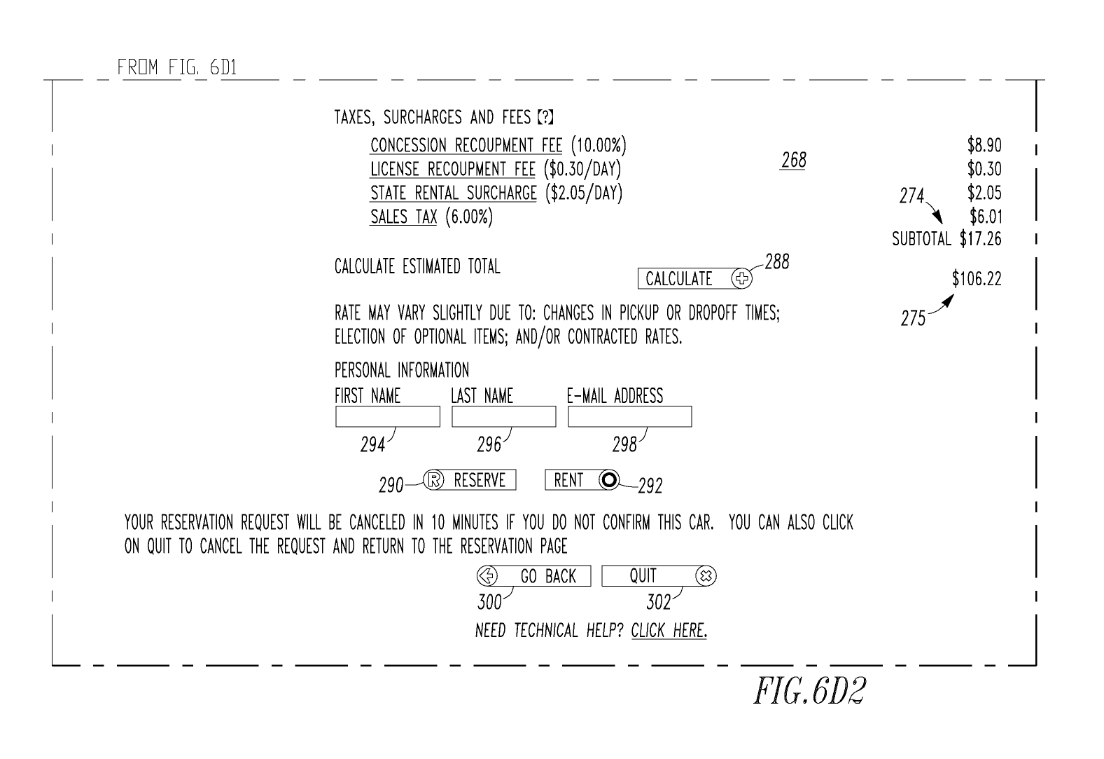

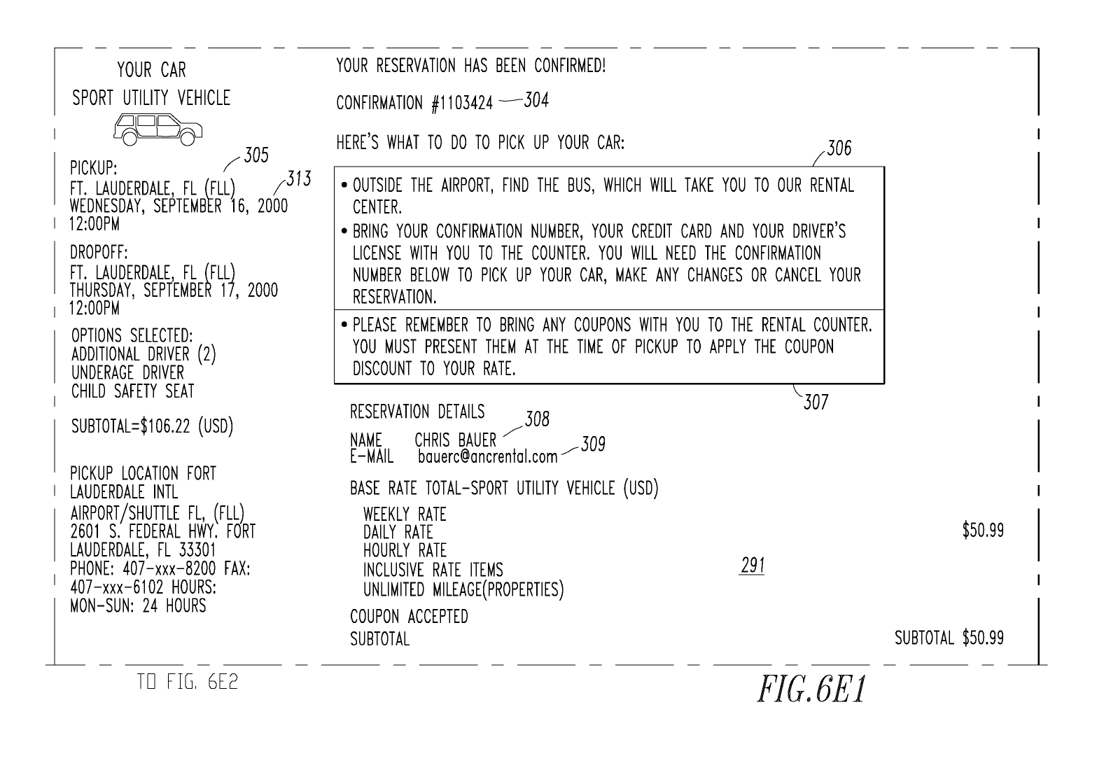

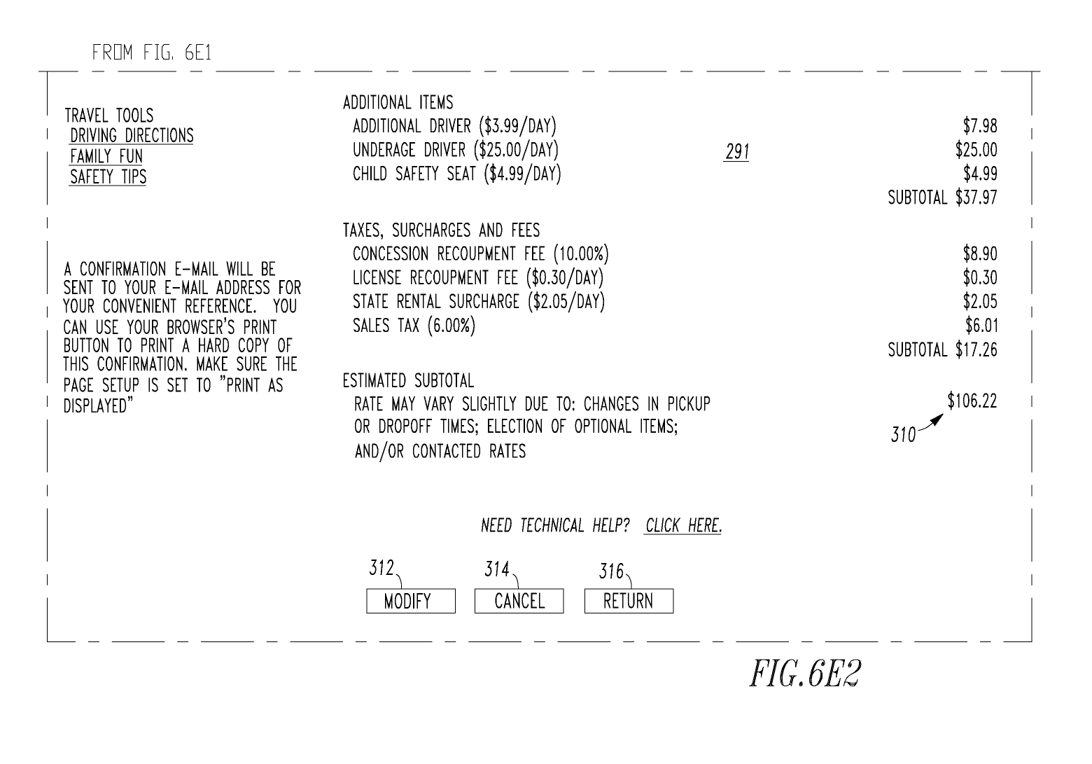

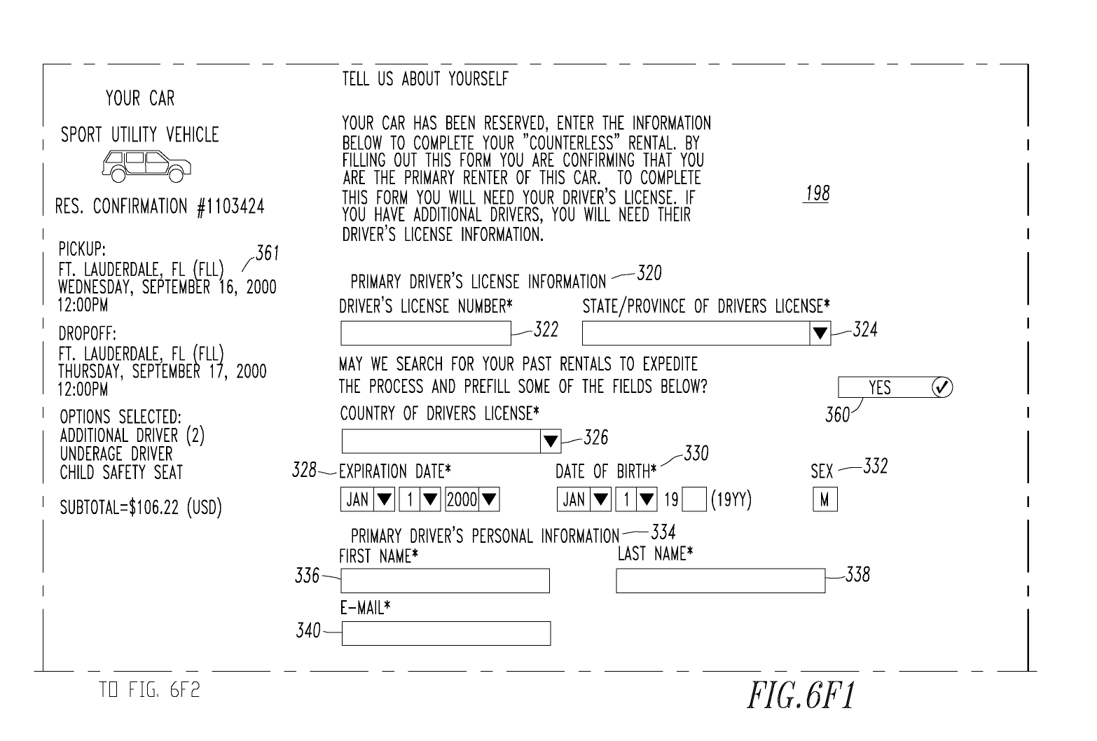

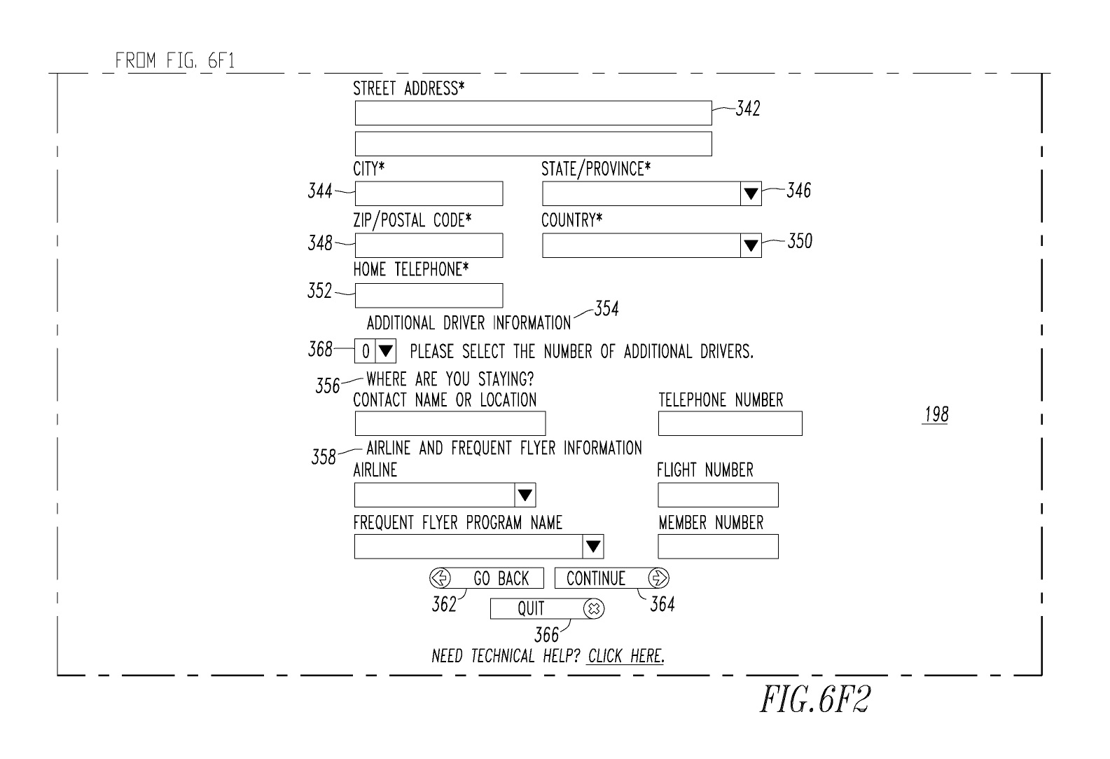

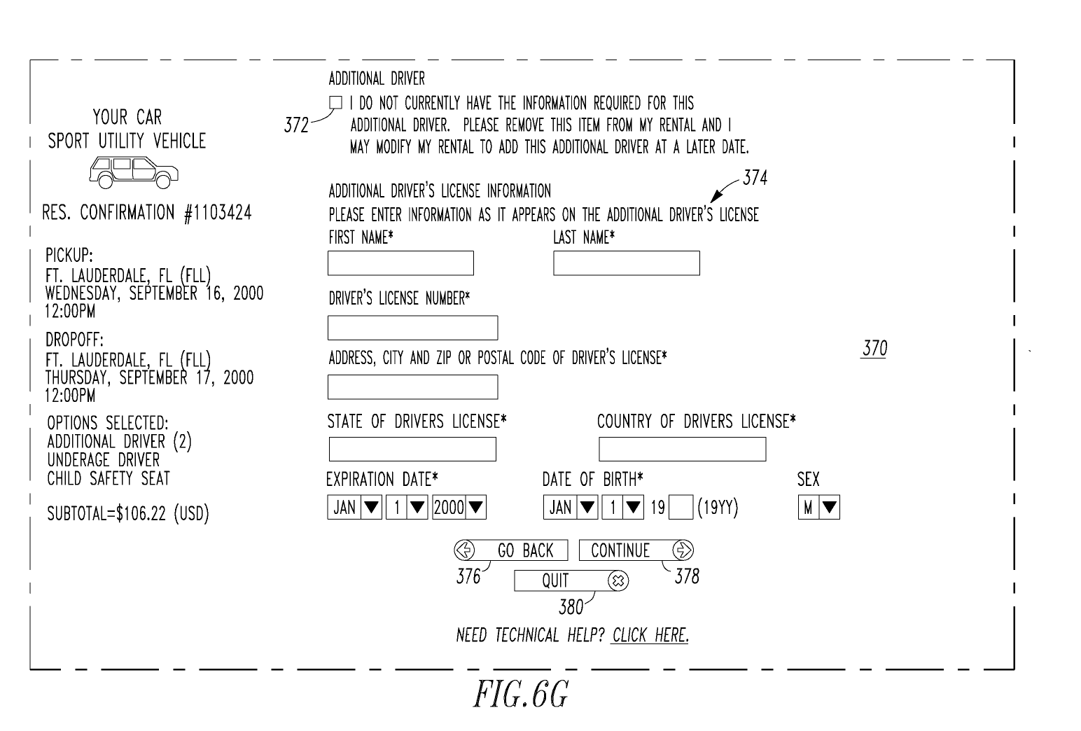

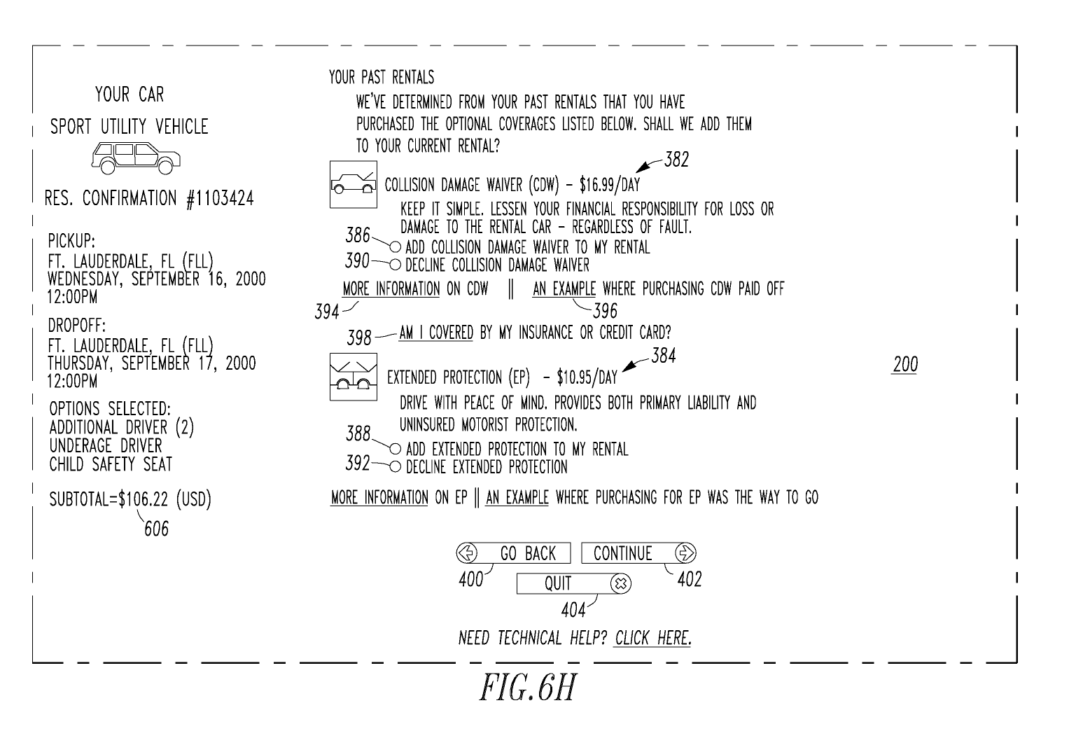

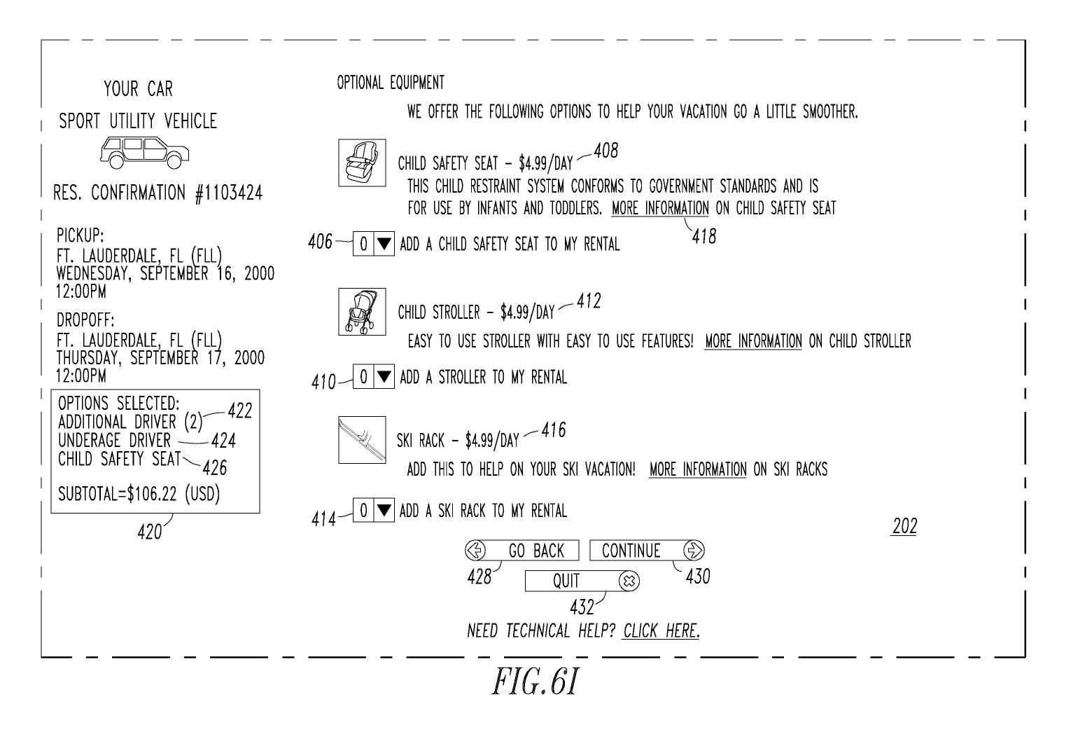

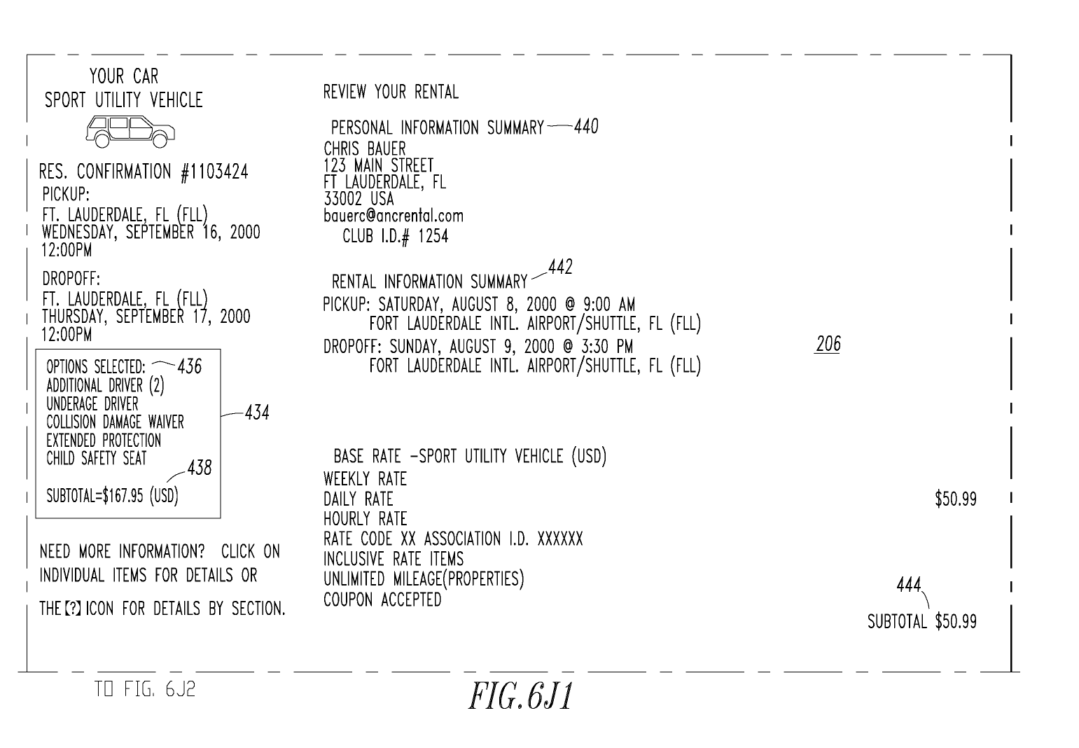

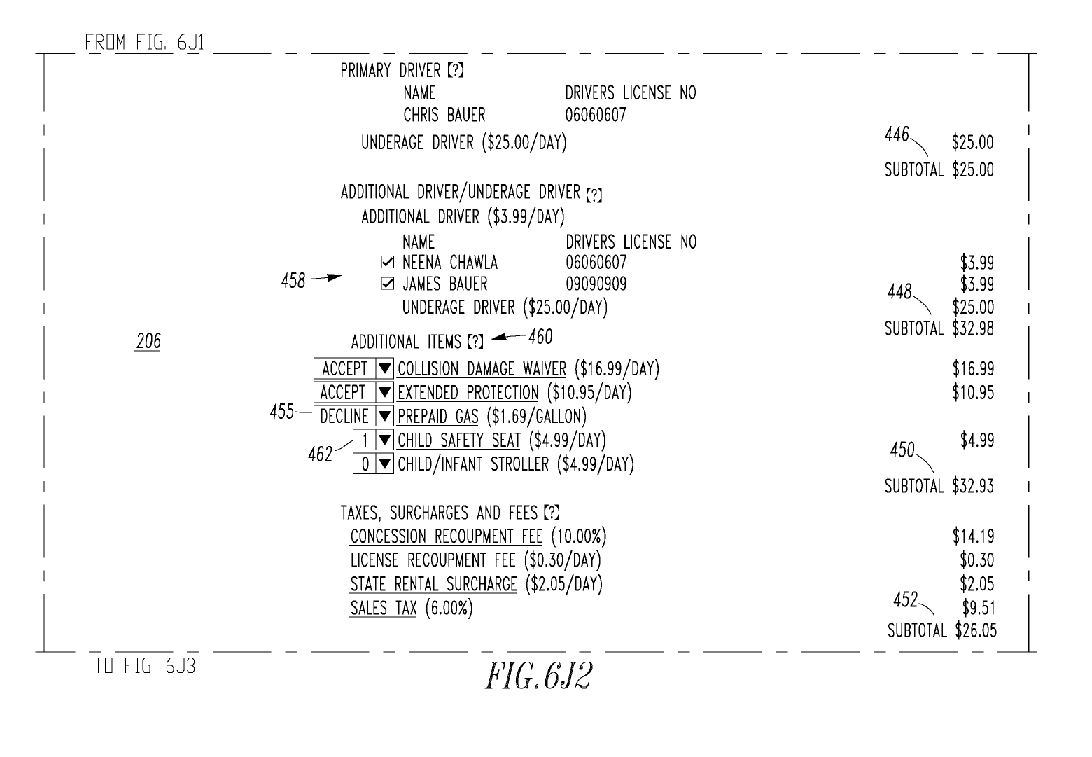

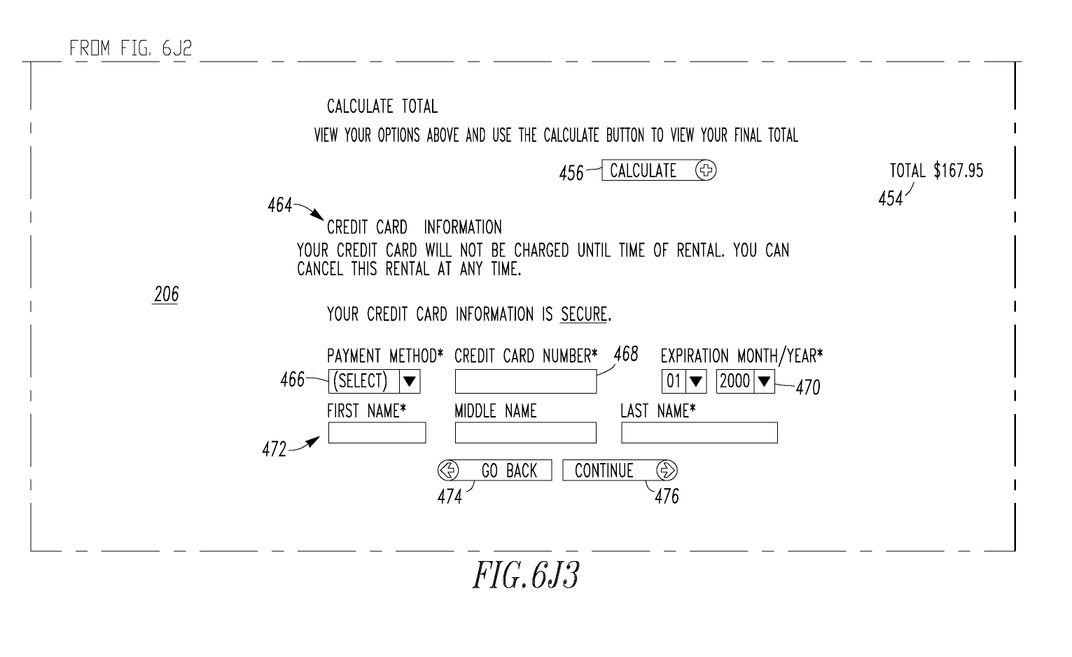

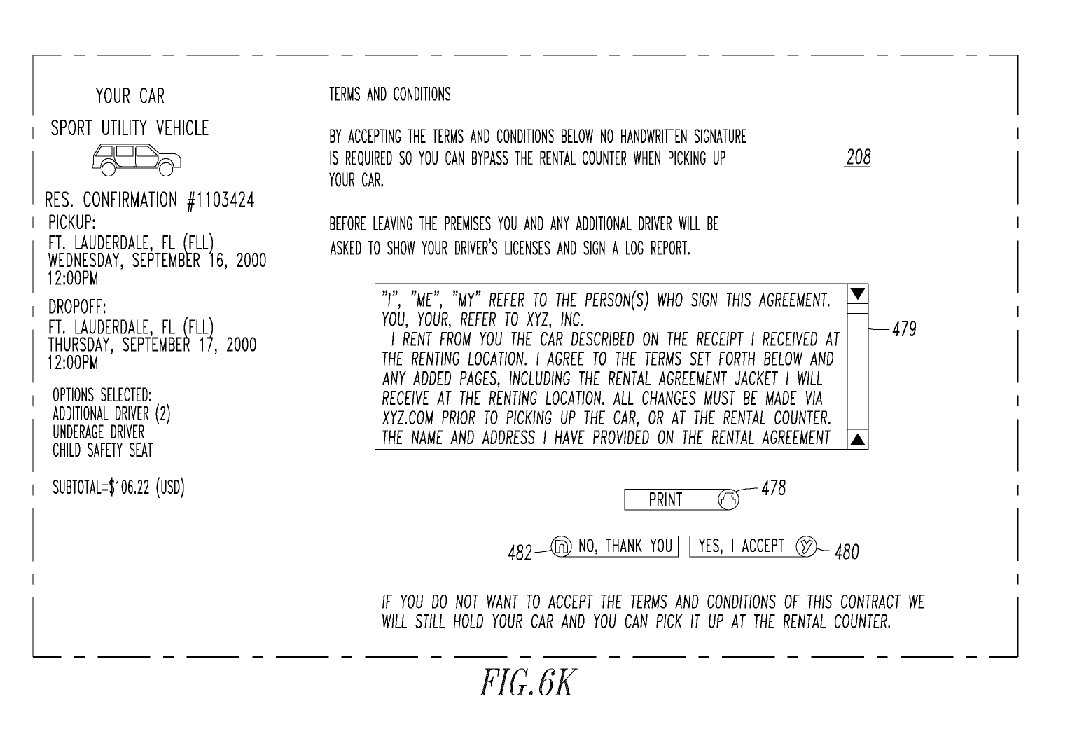

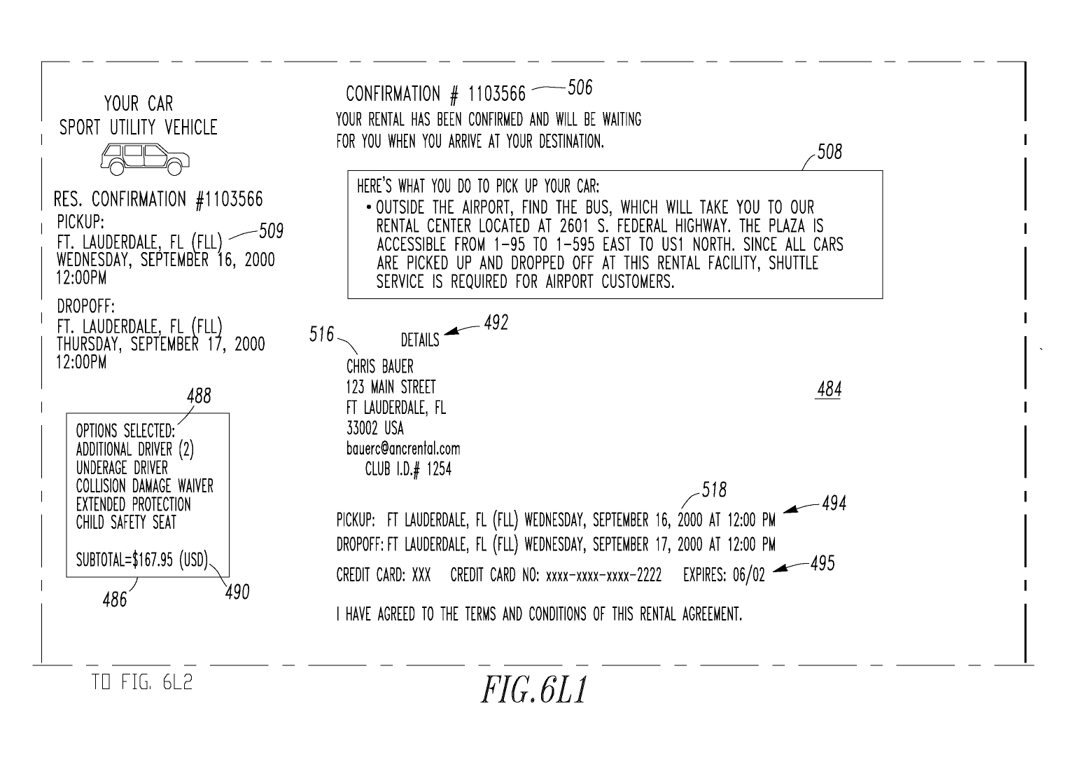

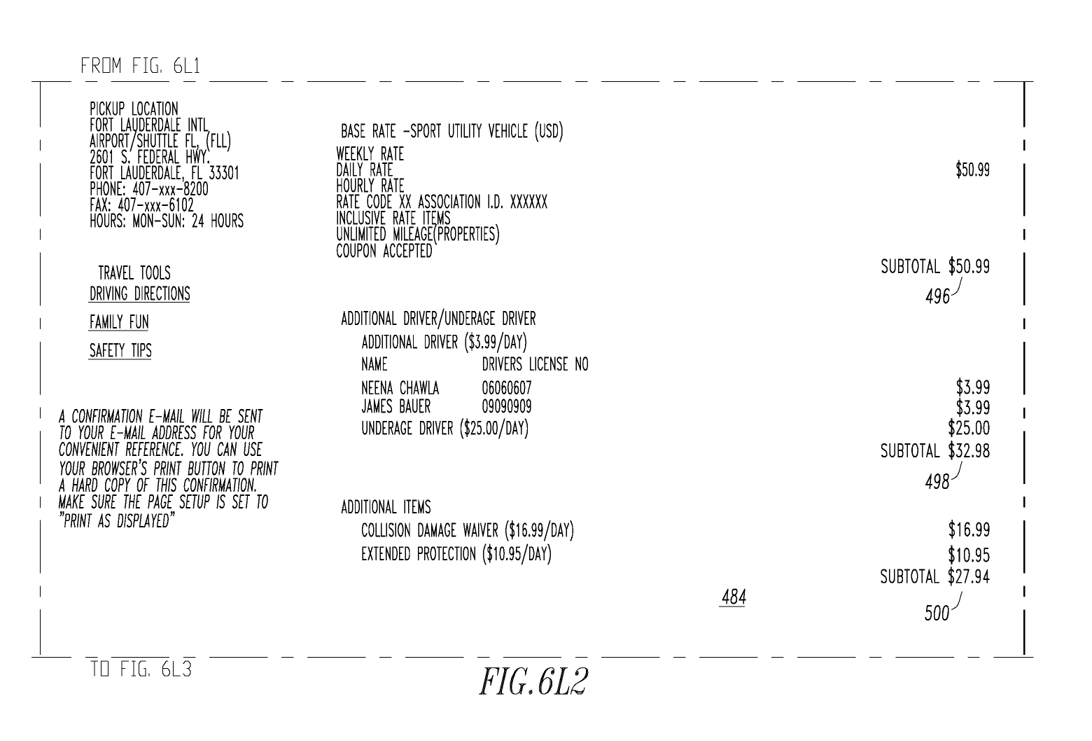

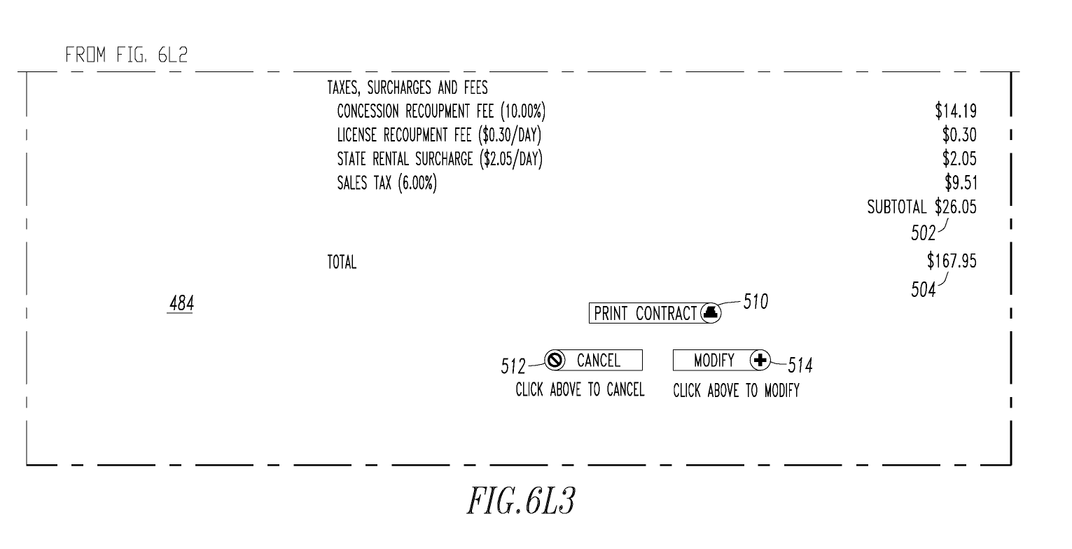

As shown in FIG. 3, at 86, from a “tell us about your trip” web page (FIG. 6B), pick-up and drop-off information and time of travel are entered for the reservation. In the event that a reservation request outside of the relevant jurisdiction (e.g., without limitation, the United States) is specified, then the information is directed to a different booking engine (not shown). Next, at 88, from a “select a vehicle” web page (FIG. 6C), the customer selects an appropriate vehicle based upon various available rental options. In turn, a rate quote 90 is calculated by the reservation system 68 of FIG. 2, in order to provide the customer with a suitable cost estimate based upon the items selected. Next, at 92, if the customer chooses to simply reserve the vehicle, then, at 94, a “reservation confirmation” web page (FIG. 6E) is displayed, in order to confirm the reservation and, thereby, inform the customer that the reservation is in the system. Then, at 96, a confirmatory e-mail message is sent to the customer. This e-mail confirms the reservation after the customer has entered all of the reservation-related information and the reservation is in the system.

On the other hand, at 92, if the customer chooses to online rent, then, at 98, a “tell us about yourself” web page (FIG. 6F) is displayed. This exemplary web page is a form which, in the exemplary embodiment, either: (a) pulls the customer's past rentals to pre-populate the form, or (b) allows the customer to manually enter personal and/or “additional driver” (FIG. 6G) information online. Next, at 100, additional sales items are offered to the customer through, for example, a “your past rentals” web page (FIG. 6H) and an “optional equipment” web page (FIG. 6I). These pages allow the customer to be educated on available optional items (e.g., CDW, EP, prepaid gas, ancillary items). Once suitably educated, at 102, a “review your rental” web page (FIG. 6J) is displayed which provides a summary of charges and captures the customer's credit card information. Next, at 104, a “terms and conditions” web page (FIG. 6K) is suitably displayed (e.g., within a pop-up window). Relevant information regarding the reservation/rental process is stored, on a temporary basis, on the database server 64 of FIG. 2 while the transaction is in progress. In addition, information for reporting purposes is also stored on the database server 64. After all the information about the reservation and the rental is entered, the web server 62 of FIG. 2 displays a rental agreement to the customer, with a button 106 entitled “I Accept”. The consumer clicks on the “I Accept” button 106 in order to complete the online rental.

At 108, a “rental confirmation” web page (FIG. 6L) is displayed. This web page displays dynamic location specific directions on what to do when the consumer reaches the selected rental facility, and a summary of charges. A “Print” button 110 permits the consumer to print the accepted rental contract.

At 112, a confirmatory e-mail message is sent to the customer. This e-mail confirms the reservation and the rental after the customer has entered all of the reservation-related and rental-related information and the reservation and rental are in the system.

In the event that the customer chose to simply reserve the vehicle, at 92, and received the confirmatory e-mail (as sent at 96), then the customer has the option of entering rental-related information after receiving the e-mail message. Preferably, the confirmatory e-mail message includes a suitable link 114 to step 98, which displays the “tell us about yourself” web page (FIG. 6F) to complete the rental agreement.

Preferably, the system provides suitable mechanisms for the customer to modify, at 116, an existing reservation, and/or to modify, at 118, an existing rental.

FIG. 4 illustrates a client/server system 120 including a client sub-system 122 and a server sub-system 124 for completing a rental agreement (RA) 126 therebetween. The client sub-system 122 includes an entry component (E) 128 entering first information 130 pertaining to a reservation of an item or service, and entering second information 132 pertaining to a rental of the item or service. The client sub-system 122 also includes a processor component (P) 133 cooperating with the entry component 128, and a communication component (COMM) 134, responsive to the processor component 133. The communication component 134 sends, at 136, the first and second information 130,132 to the server sub-system 124, and receives, at 138, from the server sub-system 124 a rental proposal 140 responsive to the sent first and second information. Preferably, the rental proposal (RP) 140 is sent as an HTML document, as provided by the server sub-system 124, and the processor component 133 processes the HTML document for display.

The client sub-system 122 further includes a display component, such as the exemplary browser 142, which employs a suitable web page (e.g., FIG. 6C) for selecting the item or service, and which employs one or more suitable web pages (e.g., FIGS. 6J and 6K) for displaying the rental proposal 140. In turn, the entry component 128 and the processor component 133 cooperate to initiate acceptance, at 144, of the rental proposal 140. The communication component 134, responsive to the acceptance, sends the acceptance, at 146, to the server sub-system 124, in order to complete the rental agreement 126 online. Preferably, the server sub-system 124 sends, at 147, the rental agreement 126 to the client sub-system 122 as an HTML document, and the processor component 133 processes the HTML document for display by the browser 142 of the client sub-system 122.

The server sub-system 124 includes a data storage component 148 storing information for a plurality of items or services, and a communication and processing component 150 receiving the first and second information 130,132 from the client sub-system 122. The communication and processing component 150 includes a communication component (COMM) 152 and a processor component (P) 154. The server sub-system 124 also includes a reservation component (RESERVE) 156 which retrieves stored information from the data storage component 148 for the items or services, and provides a reservation (RES) 158 based at least in part upon the first information and the retrieved stored information. The server sub-system 124 further includes a rental component (RENT) 160 generating the rental proposal 140 based upon the reservation 158 and the received second information.

The communication component 152 sends the rental proposal 140 to the client sub-system 122, and receives the acceptance 146 of the rental proposal from the client sub-system 122, in order to complete the rental agreement 126 online. The rental component 160 generates the rental agreement 126 at the server sub-system 124 based upon the accepted rental proposal. The communication component 152 sends the rental agreement 126 from the server sub-system 124 to the client sub-system 122. The processor component 154 cooperates with the communication component 152, the reservation component 156 and the rental component 160 to provide the reservation 158, to send the rental proposal 140 to the client sub-system 122, and to receive the acceptance 146 of the rental proposal from the client sub-system 122, in order to complete the rental agreement 126 online.

Preferably, a suitable communication system, such as a global communication network 164 (e.g., the Internet), communicates between the communication component 134 of the client system 122 and the communication component 152 of the server sub-system 124. Alternatively, the present invention is applicable to entry of reservation-related and rental-related information by employing one or more of a telephone, a global communication network, and electronic mail.

Referring to FIG. 5, regardless whether the reservation and rental were completed online, a customer (CUST) 166 has the ability to go to a rental counter 168 (associated with a rental facility 176). In the event that the reservation or rental was not completed online, then a rental agent 170 at the rental counter 168 has the ability to complete the reservation/rental transaction without going through all the questions (e.g., entry fields) at the rental counter 168 that were previously answered online (e.g., over the Internet). In turn, the rental agent 170 completes the rental by allocating a car 172 and printing the rental agreement (RA) 174. In turn, the customer 166 proceeds to the rental facility 176 to obtain the car 172.

On the other hand, if the reservation and rental were completed online, a customer 178 may still be directed to the rental counter 168, where expedited service is preferably provided, in order to obtain an optional item (e.g., a stroller 180) before obtaining a car 182 for rental. In this event, the customer 178 had previously displayed and accepted a rental proposal (and typically had displayed a rental agreement) online (e.g., at a client system). Preferably, the rental agent 184 provides expedited service to the customer 178 at the rental counter 168 based upon the rental agreement 186, and allocates the car 182 at the rental counter 168. In this instance, the rental agent 184 may also display the rental agreement 186 at the rental counter 168.

FIG. 6A is a block diagram showing a link 188 from a home web page 190 to a second web page 192, which presents an overview of: (1) the “tell us about your trip” web page 194 (FIG. 6B); (2) the “select a vehicle” web page 196 (FIG. 6C); (3) the “tell us about yourself” web page 198 (FIG. 6F); (4) the “your past rentals” web 200 (FIG. 6H) and “optional equipment” web page 202 (FIG. 6I); and (5) the “review your rental” web page 206 (FIG. 6J) and the “terms and conditions” web page 208 (FIG. 6K). A link 210 is provided from the second web page 192 to the “tell us about your trip” web page 194 of FIG. 6B.

The “tell us about your trip” web page 194 of FIG. 6B permits the user to enter reservation-related information, such as time and location information regarding a vehicle rental. This information typically includes at least some of pick-up location 212, pick-up date 214, pick-up time 216, drop-off location 218, drop-off date 220, and drop-off time 222 fields. In addition, a country of residence 224 field is provided.

In the exemplary embodiment, once the customer places the cursor on any of the country of residence 224, pick-up location 212, or drop-off location 218 fields, a suitable location search may be employed to populate the pick-up location 212 for the user, thereby assisting manual entry of the city name or code. The pick-up location 212 field may also support manual entry of the city name, city code, state or country. The drop-off location 218 preferably defaults to the pick-up location 212. The country of residence 224 field preferably employs an alphabetized list of countries with the United States (US), for example, listed both first and in alphabetical order.

Also, in the exemplary embodiment, once the customer places the cursor on any of the pick-up date 214 or drop-off date 220 fields, a suitable interactive calendar is provided for entry of the date information. Preferably, the drop-off month defaults to the pick-up month and is the first month to appear in a drop-down box (not shown).

Although the foregoing entry fields are “required” in the exemplary embodiment, the invention is applicable to data entry in which fewer or greater data fields (e.g., arrival information) are employed. The exemplary web page 194 also employs optional information 224, such as, for example, Rate Code, Promo Code, Corporate ID, and Coupon Code, as known to those skilled in the art. If the customer enters data in the Rate Code, then once a number is entered in the Corporate ID, the Applicant Code 226 field appears and is open for entry. Validation for the Applicant Code is performed on the mainframe 66 of FIG. 2.

Other optional information in the exemplary embodiment includes the Club Member ID 228 field and the Last Name 230 field. In the exemplary embodiment, in order to validate the Club Member ID 228 field on the mainframe 66 of FIG. 2, the Last Name 230 field is entered and captured. Once the customer clicks on the “Continue” button 232 to advance to the web page 196 of FIG. 6C, this validation is performed. If there is an error, then a suitable error message (not shown) is displayed. In the exemplary embodiment, if the customer enters a non-US location into the pick-up or drop-off fields, then upon selecting the “Continue” button 232, the customer is redirected to a suitable international booking engine (not shown).

As shown in FIG. 6B, suitable links are preferably provided to view 234, modify 236, and cancel 238 an existing reservation. Also, a suitable link 240 to technical help is preferably provided to further assist the customer.

FIG. 6C illustrates the exemplary “select a vehicle” web page 196 (after a calculation). This web page 196 permits the customer to select a vehicle for reservation as part of the reservation-related information. Based upon the information from FIG. 6B, the vehicle classes that are available at the requested location for the requested dates are displayed. For example, at 242, an image 244 of the vehicle, a class 246 of the vehicle, and a rental price 248 for the vehicle are initially displayed. Then, the customer clicks on the image 244 or the exemplary radio button 250, in order to reserve that particular class of vehicle. Preferably, the customer may also make an informed selection based upon the capacity 252 of the vehicle. The web page 196 preferably shows one or both of passenger capacity 254 and luggage capacity 256 as the capacity 252 of the available vehicles.

In addition to displaying the rental period and location information 258 from the information entered in FIG. 6B, the rental period price quotation 259, as quoted in the currency of the Rate Code, is received from the mainframe 66 of FIG. 2 and displayed. Also displayed are a vehicle capacity legend 260 and features 262 of the selected vehicle.

The customer may employ the “Go Back” button 264 to return to the web page 194 of FIG. 6B, or the “Continue” button 266 to proceed to the “select rental options and calculate total” web page 268 of FIG. 6D.

The web page 268 includes a Base Rate Subtotal 270, a Subtotal 271 based upon the primary driver's age, an Additional Drivers Subtotal 272, an Additional Items Subtotal 273, a Subtotal for Taxes, Surcharges and Fees 274, and an Estimated Total 275. The Additional Items section 276 shows all ancillary items for the selected pick-up location as well as insurance coverage items 277,278 (e.g., Collision Damage Waiver, Extended Protection) and prepaid gas 279. FIG. 6D shows examples of available items 280,281 (e.g., Baby Seat, Ski Rack, Stroller) that can be selected at the time of reservation for the selected rental facility. The mainframe 66 of FIG. 2 sends these items to the web server 62 for display only if they are available. Preferably, hyperlinks, such as 282, appear for each of the above items. When a user clicks on one of these links, a pop-up box (not shown) is displayed that provides descriptive information about the item.

When the customer first arrives at this exemplary web page 268, the base line item totals and Subtotal 270 are displayed along with the Taxes, Surcharges and Fees Subtotal 274, and the Estimated Total 275. Preferably, all other sections do not have line item totals or subtotals. Once the customer manipulates, for example, the drop-down box(es) 284,286 or selects items in the Additional Items section 276, these sections' subtotals disappear along with the Total 275. In order to get these subtotals and Total to appear, the customer clicks on the “Calculate” button 288. In turn, the items selected are captured and the various subtotals and Total are updated by the mainframe 66 of FIG. 2.

If the customer selects the “Reserve” button 290, then the newly calculated subtotals and Total are reflected in the “reservation confirmation” web page 291 of FIG. 6E. On the other hand, if the customer clicks on the “Rent” button 292, then the options are saved and used in the sales logic in connection with FIGS. 6H and 6I. In turn, the “tell us about yourself” web page 198 of FIG. 6F is displayed.

Although the following entry fields are “required” in the exemplary reservation and/or rental embodiments: the personal information including First Name 294, Last Name 296, and E-mail address 298 fields, the invention is applicable to data entry in which fewer or greater data fields (e.g., address information) are employed.

As alternatives to the buttons 290,292, the customer may select the “Go Back” button 300 to return to the web page 196 of FIG. 6C, or the “Quit” button 302 to quit the reservation process.

In the event that the customer entered a suitable Member ID 228 in FIG. 6B, the web page 268 displays a list (not shown) of items which are in the customer's master rental agreement (MRA) for that Member ID, as well as other items that are selectable. Here, the customer has three options: First, if no changes are made to the items which were pre-selected, then the user may “Continue” (not shown) (in the same manner as another user upon selecting the “Reserve” button 290) to the “reservation confirmation” web page 291 of FIG. 6E. Second, if changes are made, then the customer is notified by a pop-up (not shown) that he/she can either keep the pre-defined selections in the MRA or else proceed with the “Rent” option. If the customer chooses to stick with the MRA, then the selections revert back to those from the MRA user profile and the “reservation confirmation” web page 291 of FIG. 6E is displayed. Third, if the customer chooses the “Rent” button 292, then the “tell us about yourself” web page 198 of FIG. 6F is displayed. Here, personal information, such as, for example, telephone number, driver's license information, and frequent flyer information is pre-filled. However, credit card information is preferably not pre-filled and the customer is, otherwise, treated like a general (i.e., non-MRA) customer for the remainder of the rental process.

FIG. 6E shows the “reservation confirmation” web page 291, which indicates that the reservation has been confirmed and which displays a confirmation number 304. Based upon the pick-up location 305, location specific directions 306 are provided. Also, if a Coupon Code was specified in FIG. 6B, then a suitable reminder 307 such as, for example, “Don't forget to bring your coupon to the counter!” is included. Other details regarding the reservation including First Name and Last Name 308, E-mail Address 309, and a detailed summary of the costs including the Estimated Subtotal 310 are provided. As discussed above in connection with FIG. 3, a confirmation e-mail is also sent to the e-mail address 309, which was entered at field 298 of FIG. 6D.

The web page 291 preferably provides a “Modify” button 312 to display a View/Modify/Cancel jump page (not shown) with Confirmation number 304, Last Name and pick-up date 313 pre-filled. Preferably, a “Cancel” button 314 functions in a similar manner, and a “Return” button 316 returns the customer to the home page 190 of FIG. 6A.

FIG. 6F shows the “tell us about yourself” web page 198. Although certain entry fields are “required” in the exemplary web page 198 (i.e., as indicated by “*I” in FIG. 6F), the invention is applicable to data entry in which fewer or greater data fields for rental-related information are employed. For example, such information may include one or more of the following information regarding a consumer: employing at least one of driver's license information 320 (e.g., license number 322, jurisdiction 324, country 326, expiration date 328, date of birth 330, sex 332), primary driver's personal information 334 (e.g., First Name 336, Last Name 338, E-mail address 340, Street Address 342, City 344, State 346, Postal Code 348, Country 350, and Home Telephone 352), Additional Driver Information 354, travel contact information 356, and Airline and Frequent Flyer Information 358.

Preferably, suitable logic may be employed to validate the driver's license number 322 (e.g., if the state is Florida, then the number must be 12 or 13 digits, with the first digit being alpha and the remaining digits being numeric; if the state is Maryland, then the number must be 13 digits, with the first digit being alpha and the remaining digits being numeric).

An important part of this web page 198 is the “Yes” button 360 through which the customer provides permission to search for past rentals to expedite the rental process and to pre-fill some of the entry fields. If the customer pre-fills the driver's license number 322 and jurisdiction 324 fields, then the mainframe 66 of FIG. 2 employs the same in a search for an exemplary count of the three past rentals on CDW and EP for the sales process of FIG. 6H. If the user selects the “Yes” button 360, then the user is notified of the search by a pop-up box (not shown) and the mainframe 66 performs a check that the Last Name 338 matches the last name which the mainframe stores for the driver's license number 322 in the system. If there is no match, then an error message (not shown) is displayed. If there is a match, then all remaining fields in the Driver's License Information 320 and the Personal Information 334 sections are populated except for telephone number 352. Suitable validation logic employs the Date of Birth 330 field to ensure that the customer is not under the age of 18, and the Expiration Date 328 field (in view of the pick-up date 361) to ensure that the license is valid.

Alternatively, a customer may have other stored user profile information (e.g., stored in a Cookie; corresponding to the user's name or other suitable user identification) that will aid in the entry of the reservation-related and/or rental-related information for the online reservation and rental. Examples of this stored information include: (1) customer information such as, for example, address, driver's license number, and credit card information; and (2) rental preferences such as, for example, vehicle type, and additional rental items (e.g., child safety seat, other ancillary items, insurance items).

For example, the use of this stored user profile information may be enabled or disabled by the use of a suitable button (e.g., “Use Stored User Profile Information”) (not shown) on one or both of the web pages 194 of FIGS. 6B and 291 of FIG. 6E. Alternatively, this feature may be automatically enabled through a web log-in process. In this example, the system employs the stored user profile information to pre-populate the reservation-related and rental-related information for the current transaction, in order to improve the speed of information entry. The customer has the opportunity to change the stored information within the reservation/rental process, in order to fit the needs of the current reservation/rental. For example, the user may have a baby and that user's stored user profile information includes a rental preference for a child safety seat. However, for the current rental/reservation, the user does not plan to travel with the baby and, hence, seeks to complete the current reservation/rental with no child safety seat. Preferably, the system provides this function without modifying the stored user profile information.

Still referring to FIG. 6F, the customer may select the “Go Back” button 362 to return to the web page 268 of FIG. 6D, the “Continue” button 364 to proceed to the next web page 200 of FIG. 6H, or the “Quit” button 366 to quit the rental process. When the rental-related information has been suitably entered, and the “Continue” button 364 is selected (and no additional drivers are specified), then entry of all “required” fields is validated along with the driver's age, license number and expiration date. However, in the event that any additional drivers are selected, at 368, then the “additional driver” web page 370 of FIG. 6G is displayed.

At the web page 370 of FIG. 6G, the customer may: (1) select the checkbox 372; or (2) enter the additional driver's license information 374. If the checkbox 372 is selected, then the additional driver information 354 of FIG. 6F is ignored and none of the entry fields from the web page 370 is captured or validated. Otherwise, the information is captured and validated.

The customer may select the “Go Back” button 376 to return to the web page 198 of FIG. 6F, the “Continue” button 378 to proceed to the next web page 200 of FIG. 6H, or the “Quit” button 380 to quit the rental process. When the additional driver's license information 374 has been suitably entered, and the “Continue” button 378 is selected, then entry of all “required” fields is validated along with the driver's age, license number and expiration date.

FIG. 6H shows the “your past rentals” web page 200. If the customer clicked on the “Yes” button 360 of FIG. 6F, then the following exemplary logic is employed to perform a suggestive sell for the collision damage waiver (CDW) 382 and extended protection (EP) 384. However, no suggestive sell is provided for those optional insurance coverages that are selected by the exemplary add buttons 386,388.

For CDW, if the customer has two or three rentals in the past and only selected CDW less than 50% of the time, then the sales process is very informative of the product and emphasizes the benefits. If CDW was selected greater than or equal to 50% of the time, then the sales process involves suggestive selling. For example, the text “You seemed to have chosen CDW in the past, you will probably want to select this option again . . . ” is employed. Similar logic is employed for EP. Regardless, the add 386,388 and decline 390,392 buttons are not pre-selected in the exemplary embodiment. Preferably, the customer must make an affirmative selection of two of those buttons.

Although the exemplary embodiment does not employ sales logic for a prepaid gas option, it will be appreciated that such logic may be applied to this and a wide variety of other rental options. As shown with the CDW option, suitable links are provided for the customer to obtain more information 394, view an example 396 in which purchasing CDW paid off, and determine if the user is covered 398 by insurance or credit card.

The customer may select the “Go Back” button 400 to return to the web page 198 of FIG. 6F, the “Continue” button 402 to proceed to the next web page 202 of FIG. 6I (if one of the buttons 386,390 and one of the buttons 388,392 have been selected), or the “Quit” button 404 to quit the rental process.

FIG. 6I shows the “optional equipment” web page 202 that permits the inclusion of a selected count of the optional rental equipment in the rental-related information. For example, the customer may select a count 406 of Child Safety Seats 408, a count 410 of Child Strollers 412, and a count 414 of Ski Racks 416. Suitable links, such as 418 for the Child Safety seat 408, are provided to obtain additional information regarding the rental options.

This web page 202 also includes a summary 420 of all options as currently selected (e.g., two additional drivers 422, an underage driver 424, and a child safety seat 426), along with the Subtotal and Currency. If optional equipment items were selected earlier in the reservation/rental process, then those do not appear on this page. Similarly, if all available options have been previously selected, then this web page 202 is not displayed.

The customer may select the “Go Back” button 428 to return to the web page 200 of FIG. 6H, the “Continue” button 430 to proceed to the next web page 206 of FIG. 6J, or the “Quit” button 432 to quit the rental process.

FIG. 6J shows the “review your rental” web page 206. This web page 206 includes a summary 434 of all options as currently selected 436 along with the Subtotal and Currency 438. The web page 206 further includes a Personal Information Summary 440, a Rental Information Summary 442, Base Rate Subtotal 444, a Primary Driver Subtotal 446, an Additional Driver Subtotal 448, an Additional Items Subtotal 450, a Taxes, Surcharges and Fees Subtotal 452, and a Total estimate 454.

If a customer manipulates the options (e.g., chooses “Accept” from the drop-down box 455 for Prepaid Gas), then the Subtotal 450, for example, disappears along with the Total 454. In order to get the Subtotal(s) and Total to appear, the customer clicks on the “Calculate” button 456, the items selected are captured by the web server 62, and the various Subtotals and Total are updated by the mainframe 66 of FIG. 2. For example, the checkboxes 458 may be employed to deselect one or both of the additional drivers. The Additional Items section 460 shows all the ancillary items for the selected pick-up location, as well as insurance coverage items and prepaid gas, which have been sent by the mainframe 66 of FIG. 2. The exemplary optional items are displayed by the web server 62 if they have been selected through the sales process (e.g., the mainframe 66 sent them earlier in the process) The CDW, EP and Prepaid Gas options employ drop-down boxes, such as 455, with values “Accept” and “Decline”. The other ancillary optional items employ drop-down boxes, such as 462, having various counts for that option. The exemplary drop-downs allow the customer to opt in or out of an optional item.

The web page 206 further includes Credit Card Information 464 including Payment method 466 (e.g., type of credit card), Card Number 468, Expiration Date 470, and the Name 472 on the card (e.g., First Name, Middle Initial or Name, Last Name). Preferably, suitable validation of the credit card information is employed. In a preferred embodiment, a validation is performed to check that the last name on the credit card equals the last name as entered for the primary driver. If these names do not match, then a suitable error message (not shown) is displayed.

The customer may select the “Go Back” button 474 to return to the web page 202 of FIG. 6I, and the “Continue” button 476 to validate the “required” fields and proceed to the next web page 208 of FIG. 6K.

FIG. 6K shows the “terms and conditions” web page 208, which includes a “Print” button 478 to permit the customer to print the displayed terms and conditions 479, a “Yes” or “Accept” button 480 to accept the rental agreement under those terms and conditions 479, and a “No” button 482 to reject the rental agreement (but keep the reservation). The text for the rental terms and conditions 479 preferably appears within a pop-up or scrolling text box, with any state specific disclosure appearing at the bottom of static terms and conditions text. By clicking on the object (i.e., selecting the “Yes” button 480), the customer accepts the rental terms and conditions and, thereby, includes them in the rental agreement. If the customer selects the “No” button 482, then the “reservation confirmation” web page 291 of FIG. 6E is displayed. Otherwise, if the customer selects the “Yes” button 480, then the “rental confirmation” web page 484 of FIG. 6L is displayed.

FIG. 6L shows the “rental confirmation” web page 484, which includes a summary 486 of all options as currently selected 488 along with the Subtotal and Currency 490. The web page 484 further includes a Personal Information Summary 492, a Rental Information Summary 494, redacted (e.g., only the last four digits) Credit Card Information 495, Base Rate Subtotal 496, an Additional Driver Subtotal 498, an Additional Items Subtotal 500, a Taxes, Surcharges and Fees Subtotal 502, and a Total estimate 504. The web page 484 also includes a Confirmation number 506 at the top of the exemplary page, along with pick-up location specific directions 508. For example, the directions 508 include instructions for a consumer at a rental facility (e.g., in Ft. Lauderdale, Fla.). Based upon the user selection of the pick-up location 509 from the various different rental facilities, the system dynamically provides the instructions based upon the selected rental facility, in order to customize it for that selected facility. Preferably, a suitable dynamic message is also provided if the customer has selected one or more ancillary items or has used an upgrade coupon (e.g., “Don't forget to go to the Rental Counter to get your: UPGRADE/CHILD SEAT/STROLLER (inserted here—depending on what was selected)).

The web page 484 further includes a “Print” button 510 to permit the customer to print the final rental agreement, a “Cancel” button 512 to cancel the rental agreement, and a “Modify” button 514 to modify the rental agreement. The “Cancel” button 512 and the “Modify” button 514 both send the customer to a View/Modify/Cancel jump page (not shown) with Confirmation number 506, Last Name 516, and pick-up date 518 pre-filled.

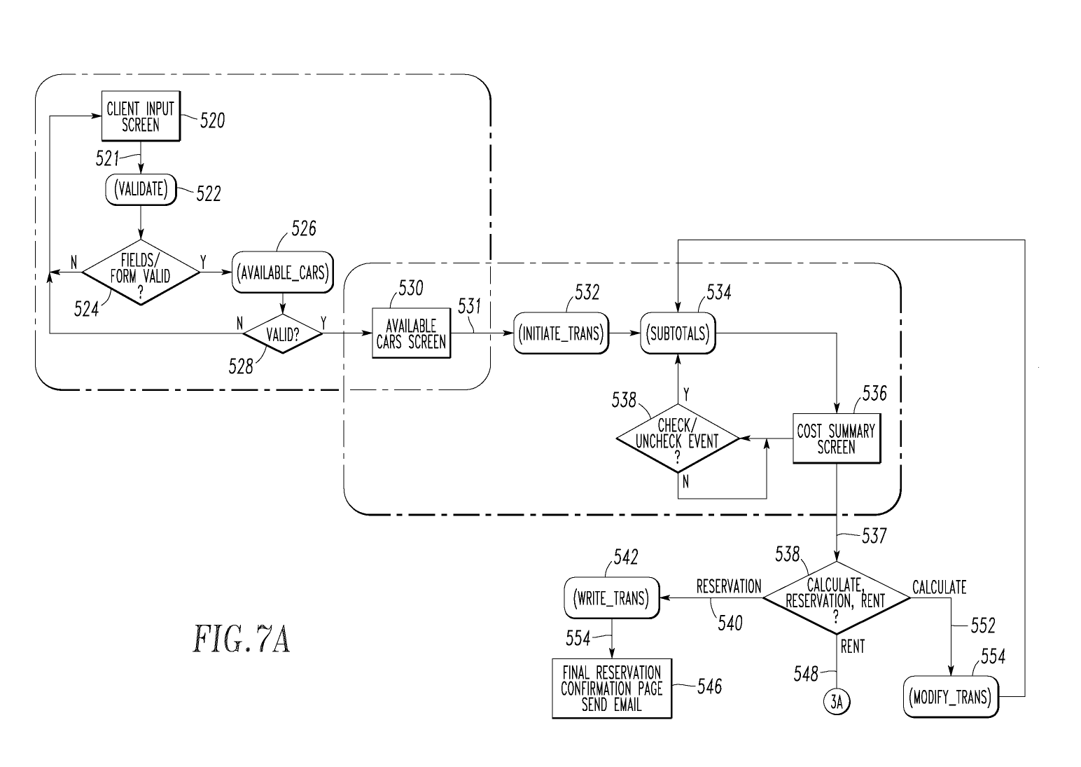

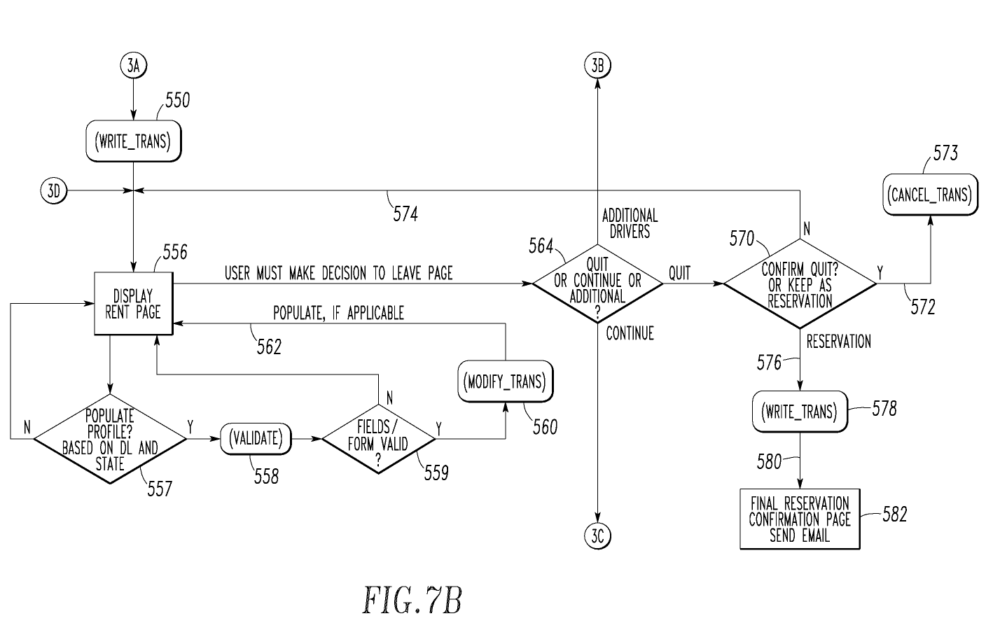

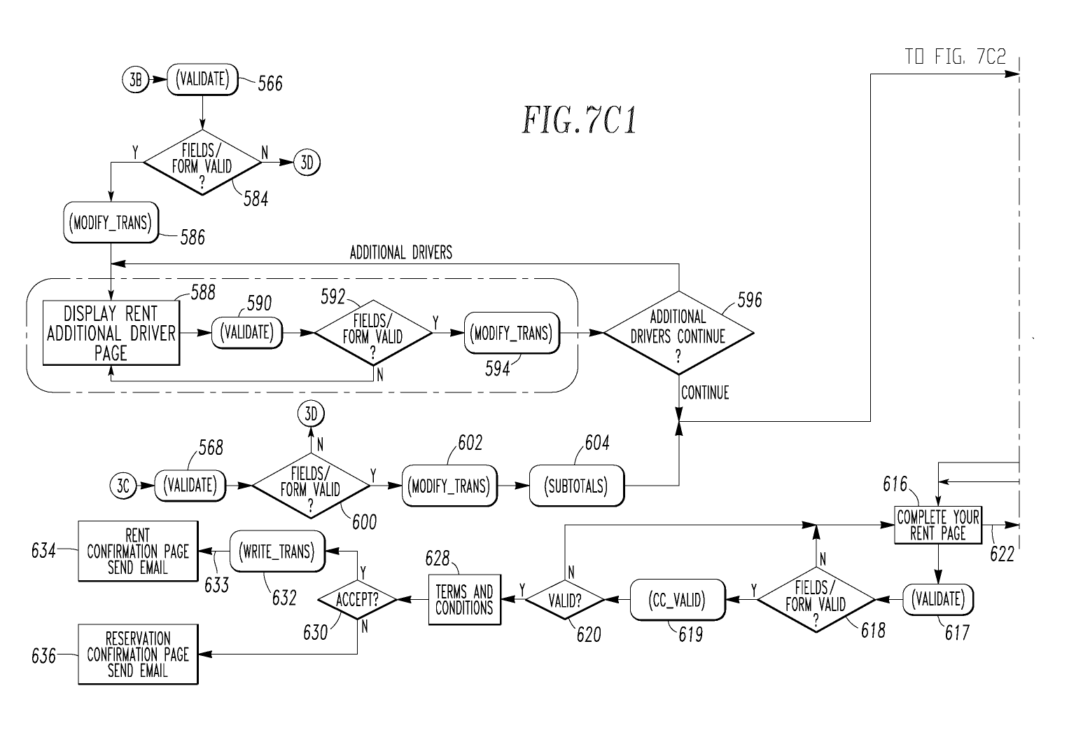

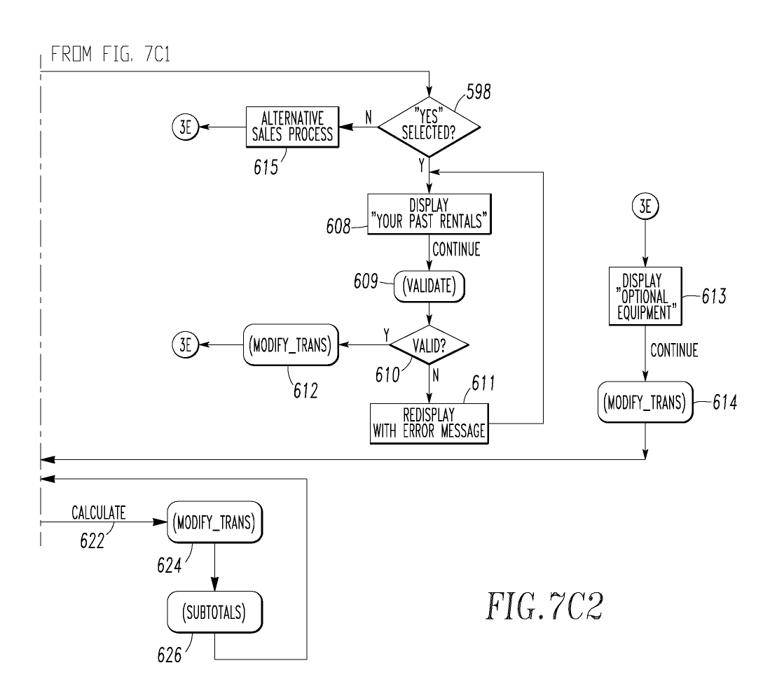

FIGS. 7A-7C are flow diagrams for the web server 62, database server 64 and mainframe 66 of FIG. 2. At 520, the web server 62 displays the web page 194 of FIG. 6B. At 521, the web server 62 detects the selection of the “Continue” button 232 and employs the database server 64 to validate some of the entry fields of the web page 194. At 524, if the entry fields are valid, then, at 526, the web server 62 employs the mainframe 66 to generate the available vehicle information for the web page 196 of FIG. 6C. On the other hand, if an entry field was not valid, then the web server 62 redisplays the web page 194, at 520, along with a suitable error message (not shown). At 528, after 526, if the mainframe 66 determines that one or more entry fields are not valid (e.g., the Rate Code of FIG. 6B), then the web server 62 redisplays, at 520, the web page 194 along with a suitable error message. Otherwise, if the entry fields of the web page 194 are valid, then the web server 62 displays the web page 196 of FIG. 6C at 530.

At 531, after the customer selects the appropriate vehicle, the web server 62 detects the selection of the “Continue” button 266 and, at 532, employs the mainframe 66 to generate the cost information for the web page 268 of FIG. 6D. In response, the web server 62 updates, at 534, the various subtotals and, at 536, displays the web page 268. At 538, the web server 62 determines if any options of the web page 268 have been changed (e.g., checked or unchecked). If not, then step 538 is repeated. Otherwise, if any of the options are changed, then the web server 62 updates, at 534, the various subtotals and, at 536, redisplays the web page 268.

As part of step 536, if the web server 62 detects, at 537, the selection of the “Calculate” button 288, the “Reserve” button 290, or the “Rent” button 292, then, at 538, the web server makes a one-of-three decision. If the “Reserve” button 290 is detected, at 540, then the web server 62 writes, at 542, a reservation transaction to the mainframe 66, which stores the transaction as part of the reservation system 68 of FIG. 2. In response to a confirmation, at 544, from the mainframe 66, the web server 62 displays, at 546, the reservation confirmation web page 291 of FIG. 6E and sends the customer an e-mail message to confirm the reservation.

Alternatively, if the “Rent” button 292 is detected, at 548, then the web server 62 writes, at 550 of FIG. 7B, a reservation transaction to the mainframe 66, which stores the transaction as part of the reservation system 68 of FIG. 2. Finally, if the “Calculate” button 288 is detected, at 552, then the web server 62 writes, at 554, a modify transaction to the mainframe 66, which re-calculates the various rental cost Subtotals and Total of FIG. 6D, after which the web server 62 updates, at 534, the various subtotals and, at 536, redisplays the web page 268.

After step 550 of FIG. 7B, the web server 62 displays, at 556, the web page 198 of FIG. 6F. At 557 (as part of 556), the web server 62 determines whether to populate the various entry fields based upon the state of the “Yes” button 360. If the button 360 is not selected, then the web server 62 continues to await selection of one of the “Yes” button 360, the “Continue” button 364, the “Go Back” button 362, and the “Additional Driver” pull-down 368. Otherwise, if the “Yes” button 360 was selected, at 557, then the web server 62 employs, at 558, the database server 64 to validate some of the entry fields (including, but not limited to, the license number 322 and jurisdiction 324 fields) of the web page 198. If an entry field was not valid, at 559, then the web server 62 redisplays the web page 198, at 556, along with a suitable error message. On the other hand, if the entry fields are valid, at 559, then, at 560, the web server 62 employs the mainframe 66, as discussed above in connection with FIG. 6F, to: (1) search for the customer's past rentals (e.g., a count of three) to obtain a history of CDW and EP selections, and (2) perform a check that the Last Name 338 matches the last name which the mainframe 66 has stored for the driver's license number 322 in the system. If there is a match, then, at 562, the web server 62 obtains from the mainframe 66 the remaining fields in the Driver's License Information 320 and the Personal Information 334 sections, except for telephone number 352, and populates the same in the entry fields of the web page 198, which is redisplayed, at 556.

At 564 (as part of 556), the web server 62 determines whether one of the “Continue” button 364, the “Go Back” button 362, and the “Additional Driver” pull-down 368 is selected. If so, and if the “Additional Driver” pull-down 368 is selected, then execution resumes at 566 of FIG. 7C. If the “Continue” button 364 is selected, then execution resumes at 568 of FIG. 7C. Otherwise, if the “Quit” button 366 is selected, then, as part of the quit logic, the web server 62 provides the user with one of two options as part of a pop-up window (not shown) that are tested, at 570: (1) if the selection of a “Yes” button is detected, at 572, then the “quit” is confirmed and a cancel transaction is written, at 573, to the mainframe 66 to cancel the reservation (and no rental is completed); and (2) if the selection of a “No” button is detected, at 574, then the “quit” is terminated (and the reservation is kept) and execution resumes at 556. If the selection of a “Reservation” button is detected, at 576, then a reservation transaction is written, at 578, to the mainframe 66, which stores the transaction as part of the reservation system 68 of FIG. 2 (and no rental is completed). In response to a confirmation, at 580, from the mainframe 66, the web server 62 displays, at 582, the reservation confirmation web page 291 of FIG. 6E, and sends the customer an e-mail message to confirm the reservation.

In FIG. 7C, after the “Additional Driver” pull-down 368 of FIG. 6F is selected, the web server 62 employs, at 566, the database server 64 to validate some of the entry fields. If an entry field was not valid, at 584, then the web server 62 redisplays, at 556 of FIG. 7B, the web page 198 of FIG. 6F along with a suitable error message. Otherwise, if the entry fields are valid, then the web server 62 initiates, at 586, a modify transaction to the mainframe 66 to update the “Additional Driver” information. Then, the web server 62 displays, at 588, the web page 370 of FIG. 6G.

Next, the web server 62 employs, at 590, the database server 64 to validate some of the entry fields. If an entry field was not valid, at 592, then the web server 62 redisplays, at 588, the web page 370 of FIG. 6G along with a suitable error message. Otherwise, if the entry fields are valid, then the web server 62 initiates, at 594, a modify transaction to the mainframe 66 to update the “Additional Driver” information.

Based upon the count from the “Additional Driver” pull-down 368 of FIG. 6F, the web server 62 determines, at 596, whether information for any additional drivers should be entered. If so, then an internal count is decremented and execution resumes, at 588, for a “second” additional driver. This process repeats until the internal count is zero, at 596, and the “Continue” button 378 of FIG. 6G is detected, at 597. Next, the web server 62 conditionally displays, at 608, the web page 200 of FIG. 6H.

If the “Continue” button 364 of FIG. 6F is selected, then execution resumes, at 568 of FIG. 7C. The web server 62 employs, at 568, the database server 64 to validate some of the entry fields of the web page 198 of FIG. 6F. If an entry field was not valid, at 600, then the web server 62 redisplays, at 556 of FIG. 7B, the web page 198 of FIG. 6F along with a suitable error message. Otherwise, if the entry fields are valid, then the web server 62 initiates, at 602, a modify transaction to the mainframe 66 to update the rental information. Next, at 604, the web server 62 updates, as needed, the Subtotal 606 of FIG. 6H before conditionally displaying, at 608, the web page 200.

At 598, if the “Yes” button 360 of FIG. 6F was selected, then at 608, the web server 62 of FIG. 2 displays the web page 200 of FIG. 6H. At this point, the customer may ADD or DECLINE the CDW, EP and Prepaid Gas options (only the CDW and EP options are shown in FIG. 6H), by using the ADD 386,388 and DECLINE 390,392 buttons. Then, after the “Continue” button 402 is detected, the web server 62 validates, at 609, the information to ensure that each option was either accepted (ADD) or declined (DECLINE). At 610, if any option was neither accepted nor declined, then the web server 62 redisplays, at 611, the web page 200 along with a suitable error message (not shown). Otherwise, at 612, the web server 62 writes a modify transaction (in order to update the selection) to the mainframe 66 of FIG. 2, before resuming execution at 613.

At 613, the web server 62 displays the web page 202 of FIG. 6I. At this point, the customer may increase or decrease the counts 406,410,414 of the respective ancillary items 408,412,416 by employing the corresponding pull-downs. Then, after the “Continue” button 430 is detected, the web server 62 writes, at 614, a modify transaction (in order to update the selected counts) to the mainframe 66 of FIG. 2, before resuming execution at 616.

On the other hand, if, at 598, the “Yes” button 360 of FIG. 6F was not selected, then, at 615, the web server 62 of FIG. 2 employs a different sales process for the CDW, EP and Prepaid Gas options. Here, the customer is presented with a web page (not shown) that describes the benefits of the particular option along with the ability to use pop-ups (not shown) for more details. The two operative actions on this web page are “Accept” or “Decline” (the particular option), after which the customer may either “Continue” or “Quit” the rental process. If the customer selects “Quit”, then a pop-up box (not shown) is displayed in order to provide two options to: (1) quit the rental transaction, but keep the reservation; or (2) quit the rental transaction and cancel the reservation. If the customer selects “Continue”, then the web server 62 validates the entry, in order to ensure that the customer suitably selected the option by either accepting or declining that option. If a proper selection was made, then the web server 62 writes a modify transaction to the mainframe 66 of FIG. 2, before displaying a subsequent web page (not shown) for the next option. Otherwise, the previous web page is redisplayed along with a suitable error message. After 615, and selection of the exemplary three options, execution resumes at 613.

At 616, the web server 62 displays the web page 206 of FIG. 6J. At 617, the web server 62 detects the selection of the “Continue” button 476 and employs the database server 64 to validate some of the entry fields of the web page 206. If the entry fields are valid, at 618, then the web server 62 employs, at 619, the mainframe 66 to validate the other entry fields of the web page 206. If, at 620, the mainframe 66 determines that one or more entry fields are not valid, then the web server 62 redisplays the web page 206, at 616, along with a suitable error message. Similarly, if the entry fields are not valid, at 618, then the web server 62 redisplays the web page 206, at 616, along with a suitable error message. Finally, if the “Calculate” button 456 of FIG. 6J is detected, at 622, then the web server 62 writes, at 624, a modify transaction to the mainframe 66, which re-calculates the various rental cost Subtotals and Total of FIG. 6J, after which the web server 62 updates, at 626, the various subtotals and, at 616, redisplays the web page 206. If there are no changes, then there is no re-calculation and the customer may continue. Otherwise, if there are changes, then the customer hits “Calculate” to continue the transaction.

On the other hand, at 620, if the mainframe 66 determines that the entry fields are valid, then the web server 62 displays, at 628, the web page 208 of FIG. 6K. If the “Accept” button 480 of FIG. 6K is detected, at 630, then the web server 62 writes, at 632, a rental transaction to the mainframe 66, which stores the rental transaction as part of the rental system 70 of FIG. 2. In response to a confirmation, at 633, from the mainframe 66, the web server 62 displays, at 634, the rental confirmation web page 484 of FIG. 6L, and sends the customer an e-mail message to confirm the reservation and rental.

Otherwise, if the selection of the “No” button 482 of FIG. 6K is detected, at 630, then the web server 62 displays, at 636, the reservation confirmation web page 291 of FIG. 6E, and sends the customer an e-mail message to confirm the reservation (an no rental is completed).

The present system and method provide substantial improvements in the completion of rental agreements online. For example, a user need not employ a master rental agreement or a user profile from any other source(s) in order to complete an online reservation and rental of a vehicle. Furthermore, such a user having a master rental agreement (or other user profile) for business (or other) purposes may still employ some of the user profile information from that master rental agreement, and modify some of that profile information for a personal vehicle rental, without modifying the business-related master rental agreement.

While for clarity of disclosure reference has been made herein to the exemplary PC 26 for displaying reservation-related and/or rental-related information, rental proposals and rental agreements, it will be appreciated that such information may be stored, printed on hard copy, be computer modified, be combined with other data, or be transmitted for display elsewhere. All such processing shall be deemed to fall within the terms “display” or “displaying” as employed herein.

Although the exemplary frame relay protocol 44 and ATM protocol 50 have been disclosed herein, the invention is applicable to any suitable communication protocol, such as, for example, TCP/IP, UDP/IP, SNA, XML, and WAP.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A method for completing a rental contract online, said method comprising the steps of:
entering reservation-related information and rental-related information for an item or service, said entering step entering: (a) said rental-related information without employing a master rental agreement, or (b) at least some of said rental-related information from a master rental agreement and allowing modification of said information from the master rental agreement for rental of said item or service without modifying the master rental agreement;
providing a reservation for said item or service based at least in part upon said reservation-related information;
creating and displaying a rental proposal based upon said reservation and said rental-related information;
accepting said rental proposal online and providing a rental contract based upon said accepted rental proposal; and
displaying said rental contract.

2. The method of claim 1 further comprising:
renting a vehicle under said rental contract.

3. The method of claim 1 further comprising:
providing rental rate requests in said reservation-related information.

4. The method of claim 3 further comprising:
selecting a vehicle for reservation in said reservation-related information.

5. The method of claim 1 further comprising:
displaying said rental contract at said client system.

6. The method of claim 1 further comprising:
selecting a vehicle for reservation in said reservation-related information.

7. A method for completing a rental contract between a client system and a server system, said method comprising the steps of:
under control of the client system,
entering first information pertaining to a reservation of an item or service, and second information pertaining to a rental of said item or service, said entering step entering: (a) said second information without employing a master rental agreement, or (b) at least some of said second information from a master rental agreement and allowing modification of said second information from the master rental agreement for rental of said item or service without modifying the master rental agreement,
sending said first information and said second information to the server system,
receiving from said server system a rental proposal based upon said first information and said second information,
displaying said rental proposal, and
accepting said rental proposal online at the client system and responsively sending an acceptance of said rental proposal to said server system to provide a rental contract based upon said acceptance of said rental proposal; and
under control of the server system,
receiving said first information and said second information from said client system,
providing a reservation based at least in part upon said first information,
generating the rental proposal based upon said reservation and said second information,
sending the rental proposal to the client system, and
receiving said acceptance of said rental proposal and generating said rental contract at the server system based upon said acceptance of said rental proposal.

8. The method of claim 7 further comprising:
including terms and conditions in the rental proposal;
displaying an object;
selecting said displayed object to accept said terms and conditions; and
including said terms and conditions in the rental contract.

9. The method of claim 7 further comprising:
sending the rental contract from the server system to the client system; and
displaying the rental contract at the client system.

10. The method of claim 7 further comprising:
renting a vehicle under the rental contract.

11. A client system for completing a rental contract with a server system, said client system comprising:
an entry component entering first information pertaining to a reservation of an item or service, and entering second information pertaining to a rental of said item or service, said entering step entering: (a) said second information without employing a master rental agreement, or (b) at least some of said second information from a master rental agreement and allowing modification of said second information from the master rental agreement for rental of said item or service without modifying the master rental agreement;
a processor component cooperating with said entry component;
a communication component, responsive to said processor component, sending said first and second information to the server system, and receiving from said server system a rental proposal responsive to said sent first and second information; and
a display component displaying said rental proposal,
said entry component and said processor component cooperating to initiate acceptance of said rental proposal, and
said communication component, responsive to said acceptance, sending said acceptance to the server system, in order to complete the rental contract online based upon said acceptance.

12. The client system of claim 11 wherein said item is a vehicle.

13. A server system for completing a rental contract with a client system, said server system comprising:
a data storage component storing information for a plurality of items or services;
a communication and processing component receiving first information pertaining to a reservation of an item or service from the client system, and receiving second information pertaining to a rental of said item or service from the client system;
a reservation component retrieving stored information from said data storage component for said items or services, and providing a reservation based at least in part upon said first information and the retrieved stored information; and
a rental component generating a rental proposal based upon said reservation and said received second information, sending the rental proposal to the client system, receiving an acceptance of the rental proposal from the client system, and completing the rental contract online based upon said acceptance of the rental proposal, said rental component receiving: (a) said second information without employing a master rental agreement, or (b) at least some of said second information from a master rental agreement and allowing modification of said second information from the master rental agreement for rental of said item or service without modifying the master rental agreement.

14. The server system of claim 13 wherein the rental is for a vehicle.

15. A method for completing a rental contract with a server system using a client system, said method comprising the steps of:
entering first information pertaining to a reservation of an item or service, and second information pertaining to a rental of said item or service, said entering step entering: (a) said second information without employing a master rental agreement, or (b) at least some of said second information from a master rental agreement and allowing modification of said second information from the master rental agreement for rental of said item or service without modifying the master rental agreement;
sending said first and second information to the server system;
receiving from said server system a rental proposal responsive to said sent first and second information;
displaying said rental proposal; and
accepting said rental proposal online and responsively sending an acceptance to the server system, in order to complete the rental contract online based upon said acceptance.

16. A method for completing a rental contract with a client system using a server system, said method comprising the steps of:
storing information for a plurality of items or services;
receiving from the client system first information pertaining to a reservation of an item or service, and second information pertaining to a rental of said item or service;
retrieving the stored information for said items or services;
providing a reservation based at least in part upon said first information and the retrieved stored information;
generating a rental proposal based upon said reservation and said received second information, said generating step generating said rental proposal: (a) without employing a master rental agreement, or (b) employing at least some of said second information from a master rental agreement and allowing modification of said second information from the master rental agreement for rental of said item or service without modifying the master rental agreement;
sending the rental proposal to the client system;
receiving an acceptance of the rental proposal from the client system; and
completing the rental contract online based upon said acceptance of the rental proposal.

17. A system for completing a rental contract, said system comprising:
a client sub-system comprising:
an entry component entering first information pertaining to a reservation of an item or service, and entering second information pertaining to a rental of said item or service, said entry component entering: (a) said second information without employing a master rental agreement, or (b) at least some of said second information from a master rental agreement and allowing modification of said second information from the master rental agreement for rental of said item or service without modifying the master rental agreement,
a processor component cooperating with said entry component,
a communication component, responsive to said processor component, sending said first and second information to a server sub-system, and receiving from said server sub-system a rental proposal responsive to said sent first and second information, and
a display component displaying said rental proposal,
said entry component and said processor component cooperating to initiate acceptance of said rental proposal, and
said communication component, responsive to said acceptance, sending said acceptance to the server sub-system;
said server sub-system comprising:
a data storage component storing information for a plurality of items or services,
a communication component receiving said first and second information from the client sub-system,
a reservation component retrieving stored information from said data storage component for said items or services, and providing a reservation based at least in part upon said first information and the retrieved stored information,
a rental component generating a rental proposal based upon said reservation and said received second information, and
a processor component cooperating with said communication component, said reservation component and said rental component to provide the reservation, to send the rental proposal to the client sub-system, to receive said acceptance of the rental proposal from the client sub-system, and to complete the rental contract online based upon said acceptance of the rental proposal; and
a communication sub-system communicating between the communication component of said client sub-system and the communication component of said server sub-system.

18. A method for completing a rental contract online and obtaining an item or service for rental, said method comprising the steps of:
entering reservation-related information and rental-related information for said item or service, said entering step entering: (a) said rental-related information without employing a master rental agreement, or (b) at least some of said rental-related information from a master rental agreement and allowing modification of said information from the master rental agreement for rental of said item or service without modifying the master rental agreement;
providing a reservation for said item or service based at least in part upon said reservation-related information;
creating and displaying a rental proposal based upon said reservation and said rental-related information;
accepting said rental proposal online and responsively providing a rental contract based upon said accepted rental proposal;
displaying said rental contract; and
going to a rental counter before obtaining said item or service for rental.

19. The method of claim 18 further comprising:
displaying said rental proposal at a client system;
accepting said rental proposal at said client system;
sending an acceptance of said rental proposal from said client system to said server system; and
receiving said acceptance at said server system and responsively completing said rental contract.

20. The method of claim 18 further comprising:
renting a vehicle as said item or service.
